(19) United States
(12) Patent Application Publication
(10) Pub. No.: US 2026/0304007 A1
(43) Pub. Date: Oct. 1, 2026

(54) COMPARATOR AND IMAGING DEVICE

(71) Applicant: Sony Semiconductor Solutions Corporation, Kanagawa (JP)

(72) Inventors: Yuken Yakushiji, Fukuoka (JP); Hideki Tanaka, Fukuoka (JP)

(21) Appl. No.: 19/478,392

(22) PCT Filed: Mar. 7, 2024
(86) PCT No.: PCT/JP2024/008848

§ 371 Date: Oct. 24, 2025

(30) Foreign Application Priority Data
May 2, 2023 (JP) 2023-075914

(51) Int. Cl. H04N 25/78; H04N 25/772

(52) U.S. Cl. CPC H04N 25/78; H04N 25/772

(57) ABSTRACT

Switching of input transistors while preventing leakage current from flowing through an input transistor not used for comparison is disclosed. In one example, a comparator includes a comparison unit that switches input transistors to which an input signal is input and compares the input signal with a reference signal, and a switch that prevents leakage current from flowing through a deactivated input transistor. The comparison unit may include a first input transistor to which the input signal is input, a second input transistor to which the input signal is input, and a reference transistor to which the reference signal is input, and the switch may include a first switch connected in parallel with the first input transistor, and a second switch connected in parallel with the second input transistor.

### TECHNICAL FIELD

The present technology relates to a comparator and an imaging device. Specifically, the present technology relates to an input-switchable comparator and an imaging device.

### BACKGROUND ART

A two-input comparator may be used to digitize signals read out at different gains. Furthermore, a comparator that compares a pixel signal representing a signal voltage corresponding to the intensity of light incident on a sensor pixel with a ramp signal selected on the basis of the signal voltage among a plurality of ramp signals has been proposed (see, for example, Patent Document 1).

### Citation List

### Patent Document

Patent Document 1: Japanese Patent Application Laid-Open No. 2022-67250

### SUMMARY OF THE INVENTION

### Problems to be Solved by the Invention

However, in the above-described related technology, when an input transistor not used for comparison is in a floating state, leakage current flows through the input transistor, potentially degrading its characteristics.

The present technology has been made in view of such circumstances, and it is therefore an object of the present technology to enable switching of input transistors while preventing leakage current from flowing through an input transistor not used for comparison.

### Solutions to Problems

The present technology has been made to solve the above-described problems, and a first aspect of the present technology is a comparator including: a comparison unit that switches a plurality of input transistors to which an input signal is input and compares the input signal with a reference signal; and a switch that prevents leakage current from flowing through an input transistor deactivated on the basis of the switching of the input transistors. This brings about an effect of enabling the switching of the input transistors while preventing leakage current from flowing through the input transistor not used for comparison.

Furthermore, in the first aspect, the comparison unit may include: a first input transistor to which the input signal is input; a second input transistor to which the input signal is input; and a reference transistor to which the reference signal is input, and the switch may include: a first switch connected in parallel with the first input transistor; and a second switch connected in parallel with the second input transistor. This brings about an effect of short-circuiting the input transistor in the floating state and stabilizing the source-drain voltage of the input transistor not used for comparison.

Furthermore, in the first aspect, when the input signal is switched to the first input transistor, the first switch may be turned off, and the second switch may be turned on, and when the input signal is switched to the second input transistor, the first switch may be turned on, and the second switch may be turned off. This brings about an effect of preventing, when the first input transistor is not used for comparison, leakage current from flowing through the first input transistor and preventing, when the second input transistor is not used for comparison, leakage current from flowing through the second input transistor.

Furthermore, in the first aspect, a first capacitor connected in series with a gate of the first input transistor, a second capacitor connected in series with a gate of the second input transistor, a first auto-zero switch connected between the gate and a drain of the first input transistor, and a second auto-zero switch connected between the gate and a drain of the second input transistor may be further included. This brings about an effect of controlling the charge accumulated in the first capacitor and the second capacitor to balance the input of the first input transistor and the input of the second input transistor.

Furthermore, in the first aspect, when the first auto-zero switch is turned on, the first switch may be turned off, and the second switch may be turned on, and when the second auto-zero switch is turned on, the first switch may be turned on, and the second switch may be turned off. This brings about an effect of preventing, during the auto-zero operation on the first input transistor side, leakage current from flowing through the second input transistor and preventing, during the auto-zero operation on the second input transistor side, leakage current from flowing through the first input transistor.

Furthermore, in the first aspect, the comparison unit may include: a first input transistor to which the input signal is input; a second input transistor to which the input signal is input; a first reference transistor to which the reference signal is input; and a second reference transistor to which the reference signal is input, and the switch may include: a first switch connected in parallel with the first input transistor; a second switch connected in parallel with the second input transistor; a third switch connected in parallel with the first reference transistor; and a fourth switch connected in parallel with the second reference transistor. This brings an effect of balancing the operation of the two-input comparator.

Furthermore, in the first aspect, when the input signal is switched to the first input transistor and the reference signal is switched to the first reference transistor, the first switch and the third switch may be turned off, and the second switch and the fourth switch may be turned on, and when the input signal is switched to the second input transistor and the reference signal is switched to the second reference transistor, the first switch and the third switch may be turned on, and the second switch and the fourth switch may be turned off. This brings about an effect of preventing, when the first input transistor and the first reference transistor are not used for comparison, leakage current from flowing through the first input transistor and the first reference transistor. This further brings about an effect of preventing, when the second input transistor and the second reference transistor are not used for comparison, leakage current from flowing through the second input transistor and the second reference transistor.

Furthermore, in the first aspect, the comparison unit may include: a first input transistor to which the input signal is input; a second input transistor to which the input signal is input; and a reference transistor to which the reference signal is input, and the switch may include: a first switch connected in series with a drain of the first input transistor; a second switch connected in series with a source of the first input transistor; a third switch connected in series with a drain of the second input transistor; and a fourth switch connected in series with a source of the second input transistor. This brings about an effect of disconnecting the input transistor in the floating state and preventing leakage current from flowing through the input transistor not used for comparison.

Furthermore, in the first aspect, the comparison unit may include: a first input transistor to which the input signal is input; a second input transistor to which the input signal is input; and a reference transistor to which the reference signal is input, and the switch may include: a first switch connected between a gate and a drain of the first input transistor; a second switch connected between the gate and a source of the first input transistor; a third switch connected between a gate and a drain of the second input transistor; and a fourth switch connected between the gate and a source of the second input transistor. This brings about an effect of short-circuiting the input transistor in the floating state and preventing leakage current from flowing through the input transistor not used for comparison.

Furthermore, in the first aspect, the comparison unit may include: a first input transistor to which the input signal is input; a second input transistor to which the input signal is input; and a reference transistor to which the reference signal is input, and the switch may include: a first switch that connects a drain of the first input transistor to fixed potential; and a second switch that connects a drain of the second input transistor to the fixed potential. This brings about an effect of connecting the drain of the input transistor in the floating state to the fixed potential and preventing leakage current from flowing through the input transistor not used for comparison.

Furthermore, in the first aspect, the comparison unit may include: a first input transistor to which the input signal is input; a second input transistor to which the input signal is input; and a reference transistor to which the reference signal is input, and the switch may include: a first switch that pulls down a gate of the first input transistor; and a second switch that pulls down a gate of the second input transistor. This brings about an effect of pulling down the gate of the input transistor in the floating state and preventing leakage current from flowing through the input transistor not used for comparison.

Furthermore, a second aspect is a comparator including: a comparison unit that compares an input signal input to an input transistor with a reference signal input to a reference transistor; and a switch connected in parallel with the input transistor. This brings about an effect of raising the comparator output to the high level by turning on the switch before AD conversion.

Furthermore, a third aspect is an imaging device including: a pixel array unit in which pixels are arranged in a matrix in a row direction and a column direction; and a column ADC unit that performs analog to digital (AD) conversion for each column on the basis of a comparison result between a pixel signal read out from the pixels and a reference signal, in which the column ADC unit includes: a comparison unit that switches a plurality of input transistors to which the pixel signal is input and compares the pixel signal with the reference signal; and a switch that prevents leakage current from flowing through an input transistor deactivated on the basis of the switching of the input transistors. This brings about an effect of enabling the switching of the input transistor used for AD conversion while preventing leakage current from flowing through the input transistor not used for AD conversion.

Furthermore, in the third aspect, the pixel signal may include a first pixel signal and a second pixel signal read out from the pixels at different gains. This brings an effect of achieving artifact-free high dynamic range (HDR).

Furthermore, in the third aspect, the comparison unit may include: a first input transistor to which the first pixel signal is input; a second input transistor to which the second pixel signal is input; and a reference transistor to which the reference signal is input, and the switch may include: a first switch connected in parallel with the first input transistor; and a second switch connected in parallel with the second input transistor. This brings about an effect of short-circuiting the input transistor in the floating state and stabilizing the source-drain voltage of the input transistor not used for AD conversion.

Furthermore, in the third aspect, the comparison unit may include: a first input transistor to which the first pixel signal is input; a second input transistor to which the second pixel signal is input; a first reference transistor to which the reference signal is input; and a second reference transistor to which the reference signal is input, and the switch may include: a first switch connected in parallel with the first input transistor; a second switch connected in parallel with the second input transistor; a third switch connected in parallel with the first reference transistor; and a fourth switch connected in parallel with the second reference transistor. This brings about an effect of balancing the operation of the two-input comparator used for AD conversion of the pixel signals read out from the pixel at different gains.

Furthermore, in the third aspect, the comparison unit may include: a first input transistor to which the first pixel signal is input; a second input transistor to which the second pixel signal is input; and a reference transistor to which the reference signal is input, and the switch may include: a first switch connected in series with a drain of the first input transistor; a second switch connected in series with a source of the first input transistor; a third switch connected in series with a drain of the second input transistor; and a fourth switch connected in series with a source of the second input transistor. This brings about an effect of disconnecting the input transistor in the floating state and preventing leakage current from flowing through the input transistor not used for AD conversion.

Furthermore, in the third aspect, the comparison unit may include: a first input transistor to which the first pixel signal is input; a second input transistor to which the second pixel signal is input; and a reference transistor to which the reference signal is input, and the switch may include: a first switch connected between a gate and a drain of the first input transistor; a second switch connected between the gate and a source of the first input transistor; a third switch connected between a gate and a drain of the second input transistor; and a fourth switch connected between the gate and a source of the second input transistor. This brings about an effect of short-circuiting the input transistor in the floating state and preventing leakage current from flowing through the input transistor not used for AD conversion.

Furthermore, in the third aspect, the comparison unit may include: a first input transistor to which the first pixel signal is input; a second input transistor to which the second pixel signal is input; and a reference transistor to which the reference signal is input, and the switch may include: a first switch that connects a drain of the first input transistor to fixed potential; and a second switch that connects a drain of the second input transistor to the fixed potential. This brings about an effect of connecting the drain of the input transistor in the floating state to the fixed potential and preventing leakage current from flowing through the input transistor not used for AD conversion.

Furthermore, in the third aspect, the comparison unit may include: a first input transistor to which the first pixel signal is input; a second input transistor to which the second pixel signal is input; and a reference transistor to which the reference signal is input, and the switch may include: a first switch that pulls down a gate of the first input transistor; and a second switch that pulls down a gate of the second input transistor. This brings about an effect of pulling down the gate of the input transistor in the floating state and preventing leakage current from flowing through the input transistor not used for AD conversion.

### BRIEF DESCRIPTION OF DRAWINGS

FIG. 1 is a block diagram illustrating a configuration example of an imaging device according to a first embodiment.

FIG. 2 is a block diagram illustrating a configuration example of a solid-state imaging device according to the first embodiment.

FIG. 3 is a block diagram illustrating a circuit configuration example of a pixel provided in the solid-state imaging device according to the first embodiment.

FIG. 4 is a block diagram illustrating another circuit configuration example of the pixel provided in the solid-state imaging device according to the first embodiment.

FIG. 5 is a timing chart illustrating waveforms of each section of low-gain readout and high-gain readout from the pixel according to the first embodiment.

FIG. 6 is a diagram illustrating a configuration example of a signal readout circuit for one column according to the first embodiment.

FIG. 7 is a diagram illustrating a configuration example of a comparator according to the first embodiment.

FIG. 8 is a timing chart illustrating waveforms of each section while the comparator according to the first embodiment is in operation.

FIG. 9 is a block diagram illustrating an example of a control signal system of a column ADC circuit according to the first embodiment.

FIG. 10 is a diagram illustrating a configuration example of a comparator according to a second embodiment.

FIG. 11 is a diagram illustrating a configuration example of a comparator according to a third embodiment.

FIG. 12 is a diagram illustrating a configuration example of a comparator according to a fourth embodiment.

FIG. 13 is a diagram illustrating a configuration example of a comparator according to a fifth embodiment.

FIG. 14 is a timing chart illustrating waveforms of each section while the comparator according to the fifth embodiment is in operation.

FIG. 15 is a diagram illustrating a configuration example of a comparator according to a sixth embodiment.

FIG. 16 is a diagram illustrating a configuration example of a comparator according to a seventh embodiment.

FIG. 17 is a diagram illustrating a configuration example of a comparator according to an eighth embodiment.

FIG. 18 is a diagram illustrating a configuration example of a comparator according to a ninth embodiment.

FIG. 19 is a diagram illustrating a configuration example of a comparator according to a tenth embodiment.

FIG. 20 is a perspective view illustrating an example of a multi-layer structure of a solid-state imaging device according to an eleventh embodiment.

FIG. 21 is a block diagram illustrating a schematic configuration example of a vehicle control system.

FIG. 22 is an explanatory diagram illustrating an example of installation positions of an imaging section.

### MODE FOR CARRYING OUT THE INVENTION

Modes for carrying out the present technology (hereinafter, referred to as embodiments) will be described below. The description will be given in the following order.
1. First embodiment (example in which a switch is connected in parallel with an input transistor in a P-channel two-input single-ended auto-zero comparator)
2. Second embodiment (example in which a switch is connected in parallel with an input transistor in an N-channel two-input single-ended auto-zero comparator)
3. Third embodiment (example in which a switch is connected in parallel with an input transistor in a P-channel two-input dual-ended auto-zero comparator)
4. Fourth embodiment (example in which a switch is connected in parallel with an input transistor in an N-channel two-input dual-ended auto-zero comparator)
5. Fifth embodiment (example in which a switch is connected in parallel with an input transistor in a P-channel one-input single-ended auto-zero comparator)
6. Sixth embodiment (example in which a switch is connected in parallel with an input transistor in an N-channel one-input single-ended auto-zero comparator)
7. Seventh embodiment (example in which a switch is connected in series with the source of an input transistor in a P-channel two-input single-ended auto-zero comparator)
8. Eighth embodiment (example in which a switch is connected between the gate and source of an input transistor in a P-channel two-input single-ended auto-zero comparator)
9. Ninth embodiment (example in which a switch that pulls down the gate of an input transistor is provided in a P-channel two-input single-ended auto-zero comparator)
10. Tenth embodiment (example in which a switch that connects the drain of an input transistor to fixed potential is provided in a P-channel two-input single-ended auto-zero comparator)
11. Eleventh embodiment (an example of a multi-layer structure of semiconductor chips forming a solid-state imaging device)
12. Application example for mobile body

### 1. First Embodiment

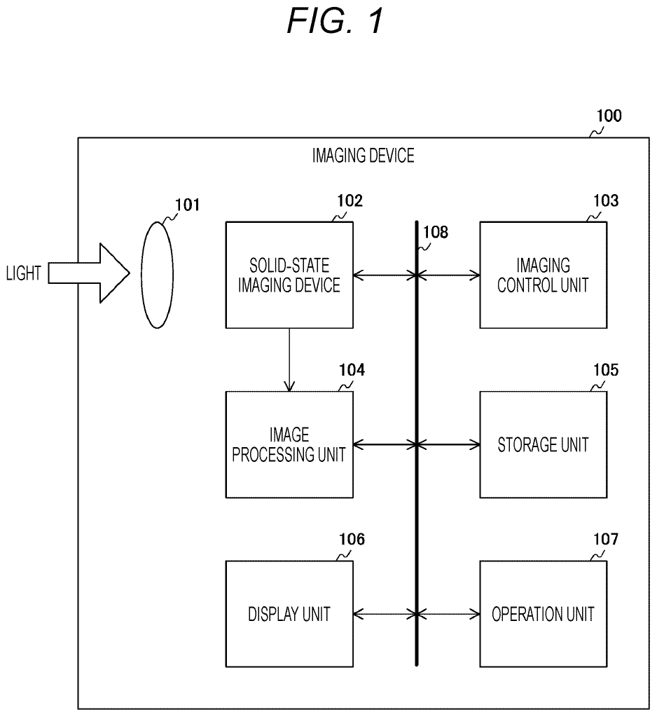

FIG. 1 is a diagram illustrating a configuration example of an imaging device according to the first embodiment.

In FIG. 1, an imaging device 100 includes an optical system 101, a solid-state imaging device 102, an imaging control unit 103, an image processing unit 104, a storage unit 105, a display unit 106, and an operation unit 107. The imaging control unit 103, the image processing unit 104, the storage unit 105, the display unit 106, and the operation unit 107 are interconnected via a bus 108. Note that the imaging device 100 may be used as a standalone unit, may be integrated into a mobile terminal such as a smartphone, or may be integrated into an authentication device or a monitoring device.

The optical system 101 causes light from a subject to enter the solid-state imaging device 102 to form a subject image on a light receiving surface of the solid-state imaging device 102. The optical system 101 can include, for example, a focus lens, a zoom lens, a diaphragm, and the like. The optical system 101 may include a plurality of lenses such as a wide-angle lens, a standard lens, and a telephoto lens.

The solid-state imaging device 102 converts light from the subject into an electric signal for each pixel, and digitizes and outputs the electric signal. The solid-state imaging device 102 may be, for example, a complementary metal oxide semiconductor (CMOS) image sensor, a charge coupled device (CCD), or an event-based vision sensor. Note that the solid-state imaging device 102 may support single-frame HDR, enabling two readouts within one frame at two different gains.

The imaging control unit 103 controls the imaging by the solid-state imaging device 102 on the basis of a command from the operation unit 107. At this time, the imaging control unit 103 can control the exposure time, the exposure amount, the imaging timing, and the like of the solid-state imaging device 102.

The image processing unit 104 performs image processing on the basis of the output from the solid-state imaging device 102. Examples of the image processing include gamma correction, white balance processing, sharpness processing, or gradation conversion processing. The image processing unit 104 may include a processor that performs processing on the basis of software. Note that the image processing unit 104 may combine pixel signals read out twice within one frame at two different gains to generate an HDR image.

The storage unit 105 stores a captured image captured by the solid-state imaging device 102, and stores imaging parameters and the like of the solid-state imaging device 102. Furthermore, the storage unit 105 can store a program for operating the imaging device 100 on the basis of software. The storage unit 105 may include a read only memory (ROM), a random access memory (RAM), and a memory card.

The display unit 106 displays a captured image or various types of information supporting the imaging operation. The display unit 106 may be a liquid crystal display or an organic electro luminescence (EL) display.

The operation unit 107 provides a user interface for operating the imaging device 100. The operation unit 107 may include, for example, a button, a dial, and a switch provided in the imaging device 100. The operation unit 107 may be implemented as a touch panel integrated into the display unit 106.

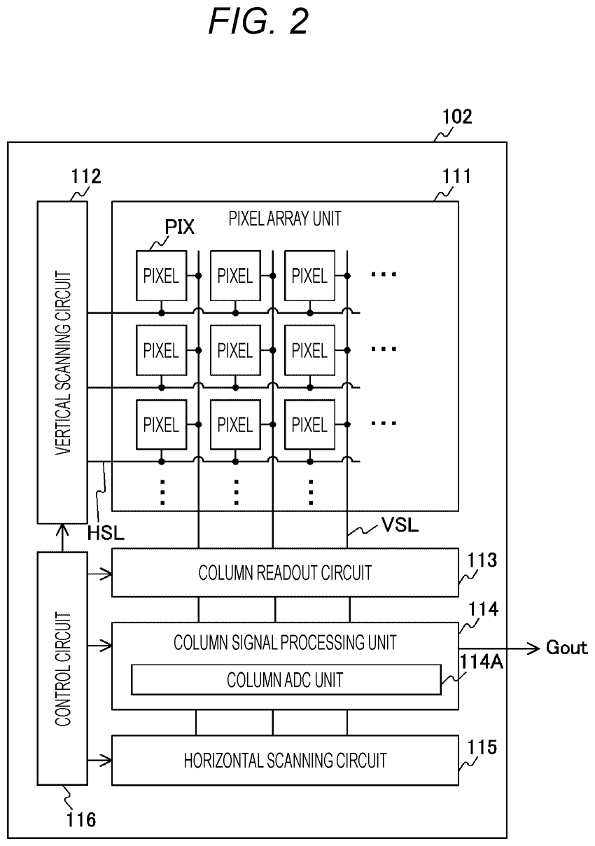

FIG. 2 is a block diagram illustrating a circuit configuration example of the solid-state imaging device according to the first embodiment.

In FIG. 2, the solid-state imaging device 102 includes a pixel array unit 111, a vertical scanning circuit 112, a column readout circuit 113, a column signal processing unit 114, a horizontal scanning circuit 115, and a control circuit 116.

The pixel array unit 111 includes a plurality of pixels PIX. The pixels PIX are arranged in a matrix along a row direction (also referred to as a horizontal direction) and a column direction (also referred to as a vertical direction). Each pixel PIX can form a source follower with the column readout circuit 113 during signal readout. Each pixel PIX is connected to a horizontal drive line HSL for each row, and is connected to a vertical signal line VSL for each column. When reading out a signal from each pixel PIX, the horizontal drive line HSL drives the pixels PIX for each row. The vertical signal line VSL transmits the signal read out from the pixel PIX to the column signal processing unit 114 for each column. Note that the pixel PIX may be read out twice within one frame at two different gains. Furthermore, the pixels PIX may be arranged in a Bayer pattern or a Quad Bayer pattern.

The pixel array unit 111 may include the vertical signal line VSL for each column. Here, the vertical signal line VSL can transmit a signal read out from the pixel PIX in the column direction.

The vertical scanning circuit 112 scans the pixels PIX to be read out in the column direction. The vertical scanning circuit 112 may include a vertical register. Here, to read out a signal from each pixel PIX, the vertical scanning circuit 112 can drive each pixel PIX for each row via the horizontal drive line HSL.

The column readout circuit 113 can form a source follower with each pixel PIX during signal readout from each pixel PIX. At this time, the column readout circuit 113 can change the potential of the vertical signal line VSL on the basis of the charge held in the pixel PIX. The column readout circuit 113 may also support constant current readout or may support capacitive load readout.

The column signal processing unit 114 processes a signal transmitted from each pixel PIX in the column direction. For example, the column signal processing unit 114 can perform correlated double sampling (CDS) processing on the basis of the signal transmitted from each pixel PIX in the column direction. Furthermore, the column signal processing unit 114 can perform analog to digital (AD) conversion processing on the basis of the signal transmitted from each pixel PIX in the column direction to output an imaging signal Gout.

The column signal processing unit 114 includes a column ADC unit 114A. The column ADC unit 114A can perform AD conversion processing in parallel for each column. At this time, the column ADC unit 114A can perform AD conversion for each column on the basis of a comparison result between the pixel signal read out from the pixel PIX and a reference signal. Here, the column ADC unit 114A can be provided with a comparator that compares the pixel signal read out from the pixel PIX with the reference signal for each column. The comparator can switch a plurality of input transistors to which the pixel signal is input to compare the pixel signal with the reference signal. The comparator can be provided with a switch that prevents leakage current from flowing through an input transistor deactivated on the basis of the switching of the input transistors. The comparator may be a two-input comparator capable of switching between a pixel signal read out at low gain and a pixel signal read out at high gain.

The horizontal scanning circuit 115 scans the pixels PIX to be read out in the row direction. The horizontal scanning circuit 115 may include a horizontal register.

The control circuit 116 controls the vertical scanning circuit 112, the column readout circuit 113, the column signal processing unit 114, and the horizontal scanning circuit 115. For example, the control circuit 116 can control the scanning timing in the column direction, the scanning timing in the row direction, the operation timing of the column readout circuit 113, and the processing timing of the column signal processing unit 114.

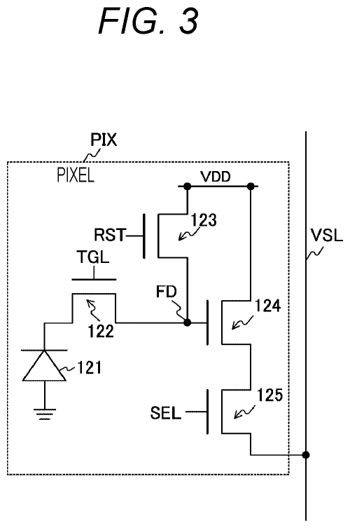

FIG. 3 is a block diagram illustrating a circuit configuration example of the pixel provided in the solid-state imaging device according to the first embodiment.

In FIG. 3, the pixel PIX includes a photodiode 121, a transfer transistor 122, a reset transistor 123, an amplification transistor 124, a selection transistor 125, and a floating diffusion FD. A metal oxide semiconductor (MOS) transistor can be used as the transfer transistor 122, the reset transistor 123, the amplification transistor 124, and the selection transistor 125.

The amplification transistor 124 and the selection transistor 125 are connected in series. The photodiode 121 has its cathode connected to the floating diffusion FD via the transfer transistor 122. Furthermore, the floating diffusion FD is connected to a power supply VDD via the reset transistor 123. Furthermore, the power supply VDD is connected to the vertical signal line VSL via the series circuit of the amplification transistor 124 and the selection transistor 125. The amplification transistor 124 has its gate connected to the floating diffusion FD.

A transfer signal TGL is applied to the gate of the transfer transistor 122. A reset signal RST is applied to the gate of the reset transistor 123. A selection signal SEL is applied to the gate of the selection transistor 125. The transfer signal TGL, the reset signal RST, and the selection signal SEL can be transmitted to each pixel PIX via the horizontal drive line HSL illustrated in FIG. 2.

When the transfer transistor 122 is turned on, the charge accumulated in the photodiode 121 is transferred to the floating diffusion FD. Then, when the selection transistor 125 is turned on, the source potential of the amplification transistor 124 changes according to the potential of the floating diffusion FD. Then, the source potential of the amplification transistor 124 is applied to the vertical signal line VSL via the selection transistor 125 and transmitted via the vertical signal line VSL. Furthermore, when the reset transistor 123 is turned on, the charge accumulated in the floating diffusion FD is discharged.

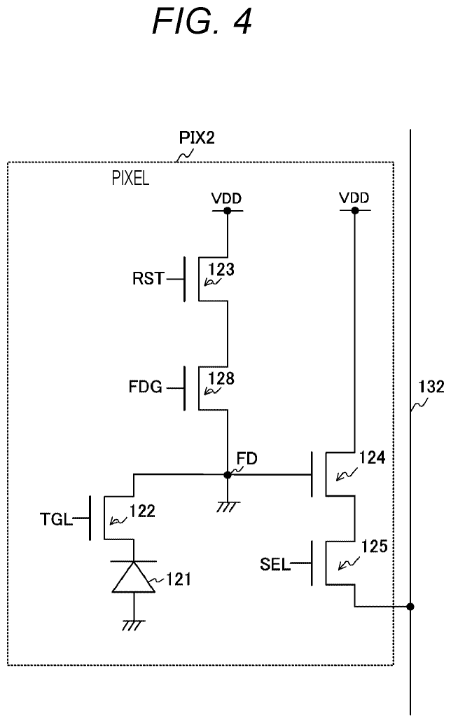

FIG. 4 is a block diagram illustrating another circuit configuration example of the pixel provided in the solid-state imaging device according to the first embodiment.

In FIG. 4, the solid-state imaging device 102 may include a pixel PIX2 instead of the pixel PIX. The pixel PIX2 further includes a switching transistor 128, compared to the pixel PIX. The pixel PIX2 may be read out twice within one frame at two different gains. The other components of the pixel PIX2 are similar to those of the pixel PIX.

The switching transistor 128 switches the conversion efficiency in the amplification transistor 124. The switching transistor 128 is connected between the floating diffusion FD and the reset transistor 123. A switching signal FDG is applied to the gate of the switching transistor 128.

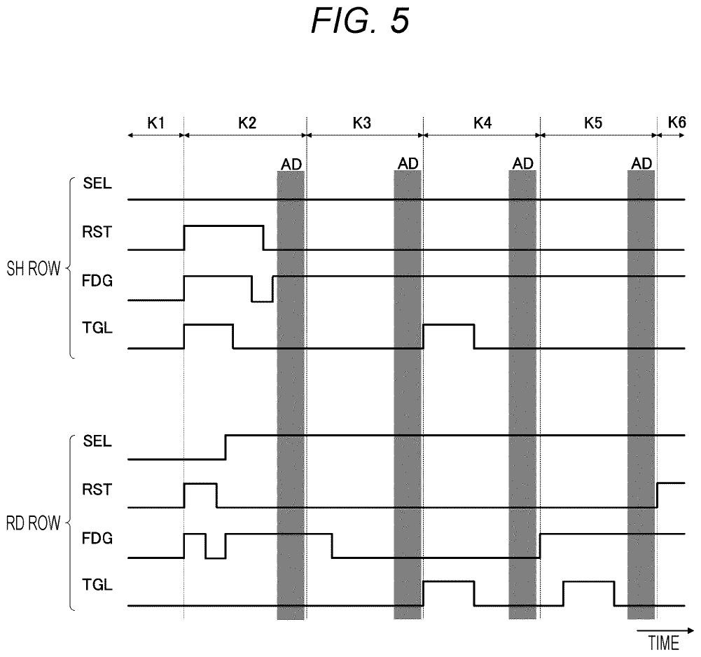

FIG. 5 is a timing chart illustrating waveforms of each section of low-gain readout and high-gain readout from the pixel according to the first embodiment. Note that an SH row indicates a shutter row, and an RD row indicates a readout row. After the SH row is performed, the RD row is performed. At this time, the SH row can set the reference for the start of accumulation in the RD row.

In FIG. 5, in the SH row, the selection signal SEL is set to a low level, and the selection transistor 125 is turned off. During a non-selection period K1, the transfer signal TGL, the reset signal RST, and the switching signal FDG are maintained at the low level. Then, upon completion of the non-selection period K1, low-gain P-phase readout K2 is performed. At this time, the transfer signal TGL, the reset signal RST, and the switching signal FDG rise, the charge in the photodiode 121 and floating diffusion FD is discharged, and the conversion efficiency in the amplification transistor 124 is reduced.

Thereafter, in the low-gain P-phase readout K2, after the transfer signal TGL falls, the switching signal FDG falls, and further, the reset signal RST falls. Then, after the switching signal FDG rises again, AD conversion processing is performed. Here, by temporarily driving the switching signal FDG to the low level before the reset signal RST falls, the floating diffusion FD can be coupled to the switching transistor 128. Therefore, the potential of the floating diffusion FD can be boosted, and the charge can be easily transferred from the photodiode 121.

Next, high-gain P-phase readout K3 is performed. At this time, AD conversion processing is performed while the transfer signal TGL, the reset signal RST, and the switching signal FDG are maintained at similar levels to those during the low-gain P-phase readout K2.

Next, high-gain D-phase readout K4 is performed. At this time, the transfer signal TGL rises, and the charge in the photodiode 121 is discharged. Then, after the transfer signal TGL falls, AD conversion processing is performed. Here, during the high-gain D-phase readout K4, the reset signal RST is set to the low level. Therefore, the floating diffusion FD is in a floating state, and the floating diffusion FD can be coupled to the transfer transistor 122. Therefore, the potential of the floating diffusion FD can be boosted, and the charge can be easily extracted from the photodiode 121.

Next, low-gain D-phase readout K5 is performed. At this time, AD conversion processing is performed while the level of the reset signal RST is maintained, and then the processing proceeds to a non-selection period K6.

In the RD row, during the non-selection period K1, the selection signal SEL, the transfer signal TGL, the reset signal RST, and the switching signal FDG are maintained at the low level. Then, upon completion of the non-selection period K1, the low-gain P-phase readout K2 is performed. At this time, the reset signal RST and the switching signal FDG rise, the charge in the floating diffusion FD is discharged, and the conversion efficiency in the amplification transistor 124 is reduced.

Thereafter, in the low-gain P-phase readout K2, after the switching signal FDG falls, the reset signal RST falls. Then, after the switching signal FDG rises again, the selection signal SEL rises, and AD conversion processing is performed. Here, by temporarily driving the switching signal FDG to the low level before the reset signal RST falls, the floating diffusion FD can be coupled to the switching transistor 128. Therefore, the potential of the floating diffusion FD can be boosted, and the charge can be easily transferred from the photodiode 121.

Next, the high-gain P-phase readout K3 is performed. At this time, after the switching signal FDG falls and the conversion efficiency in the amplification transistor 124 is increased, AD conversion processing is performed.

Next, the high-gain D-phase readout K4 is performed. At this time, the transfer signal TGL rises, and the charge in the photodiode 121 is transferred to the floating diffusion FD. Then, after the transfer signal TGL falls, AD conversion processing is performed. Here, during the high-gain D-phase readout K4, the reset signal RST is set to the low level. Therefore, the floating diffusion FD is in a floating state, and the floating diffusion FD can be coupled to the transfer transistor 122. Therefore, the potential of the floating diffusion FD can be boosted, and the charge can be easily extracted from the photodiode 121.

Next, the low-gain D-phase readout K5 is performed. At this time, the switching signal FDG rises, and the conversion efficiency in the amplification transistor 124 is reduced. Thereafter, the transfer signal TGL rises, and the charge in the photodiode 121 is transferred to the floating diffusion FD. Then, after the transfer signal TGL falls and AD conversion processing is performed, the processing proceeds to the non-selection period K6. Here, by driving the transfer signal TGL to the high level after the switching signal FDG rises, the capacitance viewed from the amplification transistor 124 can be increased. Therefore, it is possible to increase the charge that can be received from the photodiode 121, and it is possible to easily extract the charge accumulated in the photodiode 121.

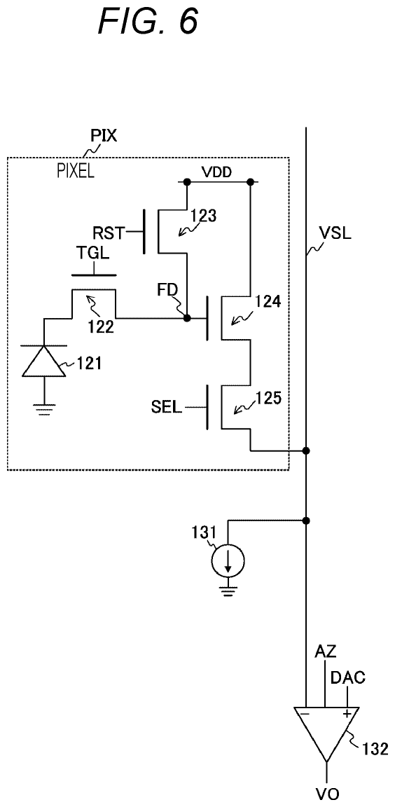

FIG. 6 is a diagram illustrating a configuration example of a signal readout circuit for one column according to the first embodiment.

In FIG. 6, the signal readout circuit includes a current source 131 and a comparator 132.

The current source 131 can form a source follower with the pixel PIX via the vertical signal line VSL during signal readout. In HDR, the pixel PIX2 can be used instead of the pixel PIX. The current source 131 can be provided for each column in the column readout circuit 113. The current source 131 is connected to the vertical signal line VSL. The current source 131 may be a MOS transistor.

The comparator 132 can switch a plurality of input transistors to which the pixel signal is input via vertical signal line VSL to compare the pixel signal with a reference signal DAC. The vertical signal line VSL is connected to the inverting input of the comparator 132. The reference signal DAC is input to the non-inverting input of the comparator 132. The reference signal DAC can include, for example, a ramp signal. Furthermore, an auto-zero signal AZ is input to the comparator 132. The auto-zero signal AZ activates auto-zero operation during an auto-zero period. In the auto-zero operation, the charge accumulated in the capacitance of the comparator 132 can be controlled to balance the non-inverting input and the inverting input. The comparator 132 can be provided for each column in the column ADC unit 114A.

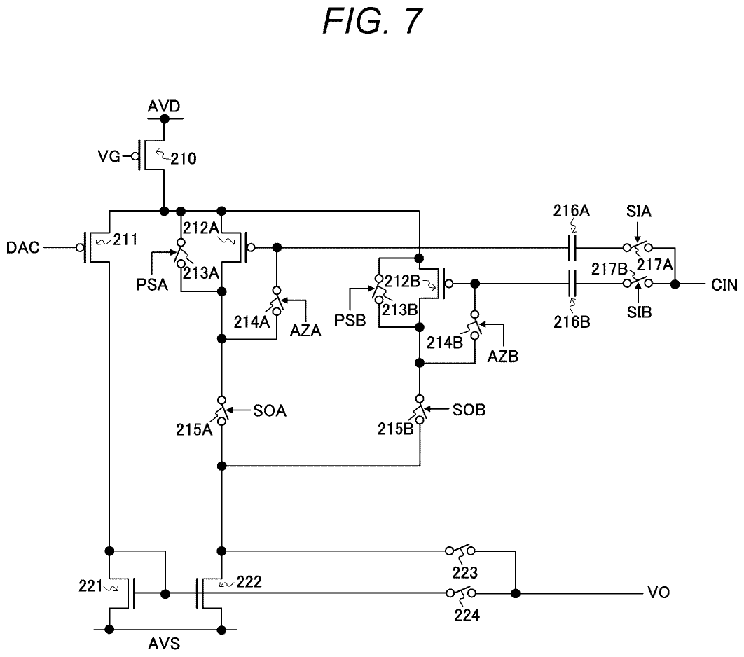

FIG. 7 is a diagram illustrating a configuration example of the comparator according to the first embodiment.

In FIG. 7, the comparator 132 serves as a P-channel two-input single-ended auto-zero comparator. At this time, the comparator 132 outputs an output voltage VO corresponding to a difference between an input signal CIN and the reference signal DAC after balancing the input signal CIN on the basis of the auto-zero operation. The input signal CIN may be, for example, a pixel signal read out twice within one frame from the pixel PIX2 at two different gains. The comparator 132 includes P-channel field effect transistors 210, 211, 212A, and 212B, N-channel field effect transistors 221 and 222, and capacitors 216A and 216B. Furthermore, the comparator includes switches 213A, 214A, 215A, 217A, 213B, 214B, 215B, 217B, 223, and 224. Note that the P-channel field effect transistors 211, 212A, and 212B are examples of the comparison unit recited in the claims. The P-channel field effect transistors 212A and 212B are examples of the input transistor recited in the claims. The P-channel field effect transistor 211 is an example of the reference transistor recited in the claims.

The P-channel field effect transistor 211 and the N-channel field effect transistor 221 are connected in series with each other. The P-channel field effect transistors 212A and 212B are connected in parallel with each other. The P-channel field effect transistor 212A has its drain connected to the drain of the N-channel field effect transistor 222 via the switch 215A. The P-channel field effect transistor 212B has its drain connected to the drain of the N-channel field effect transistor 222 via the switch 215B. The switches 215A and 215B are turned on/off on the basis of output switching signals SOA and SOB, respectively. The P-channel field effect transistors 211, 212A, and 212B have their sources connected to power supply potential AVD via the P-channel field effect transistor 210. The P-channel field effect transistor 212A can be used for the input of the pixel signal read out from pixel PIX2 at low gain. The P-channel field effect transistor 212B can be used for the input of the pixel signal read out from pixel PIX2 at high gain. A bias voltage VG is applied to the gate of the P-channel field effect transistor 210. The P-channel field effect transistor 210 can operate as a constant current source on the basis of the bias voltage VG.

The switch 214A is connected between the gate and drain of the P-channel field effect transistor 212A. The switch 214B is connected between the gate and drain of the P-channel field effect transistor 212B. The switches 214A and 214B are turned on/off on the basis of auto-zero signals AZA and AZB, respectively. At this time, when the switch 214A is turned on, the switch 213A is turned off, and the switch 213B is turned on. When the switch 214B is turned on, the switch 213A is turned on, and the switch 213B is turned off. Note that the switches 214A and 214B are examples of the auto-zero switch recited in the claims.

The switch 213A can prevent leakage current from flowing through the P-channel field effect transistor 212A deactivated on the basis of the switching of the P-channel field effect transistor 212A. The switch 213A is connected in parallel with the P-channel field effect transistor 212A. The switch 213B can prevent leakage current from flowing through the P-channel field effect transistor 212B deactivated on the basis of the switching of the P-channel field effect transistor 212B. The switch 213B is connected in parallel with the P-channel field effect transistor 212B. The switches 213A and 213B are turned on/off on the basis of off-leak signals PSA and PSB, respectively. At this time, when the input signal CIN is switched to the P-channel field effect transistor 212A, the switch 213A is turned on, and the switch 213B is turned off. When the input signal CIN is switched to the P-channel field effect transistor 212B, the switch 213A is turned off, and the switch 213B is turned on.

The switches 217A and 217B have their input ends connected together, and the input signal CIN is input to the input ends of the switches 217A and 217B. The switch 217A has its output end connected to the gate of the P-channel field effect transistor 212A via the capacitor 216A. The switch 217B has its output end connected to the gate of the P-channel field effect transistor 212B via the capacitor 216B. The switches 217A and 217B are turned on/off on the basis of input switching signals SIA and SIB, respectively.

The N-channel field effect transistors 221 and 222 have their sources connected to power supply potential AVS. The power supply potential AVS may be lower than the power supply potential AVD, or may be a ground potential. The N-channel field effect transistors 221 and 222 have their gates connected to the drain of N-channel field effect transistor 221. At this time, the N-channel field effect transistors 221 and 222 can serve as a current mirror.

The switch 223 has its input end connected to the drain of the N-channel field effect transistor 222. The switch 224 has its input end connected to the gates of the N-channel field effect transistors 221 and 222. The switches 223 and 224 have their output ends connected together, and the output voltage VO of the comparator 132 is output from the output ends of the switches 223 and 224. During the AD conversion period, the switch 223 is turned on, and the switch 224 is turned off. During the auto-zero period, the switch 223 is turned off, and the switch 224 is turned on.

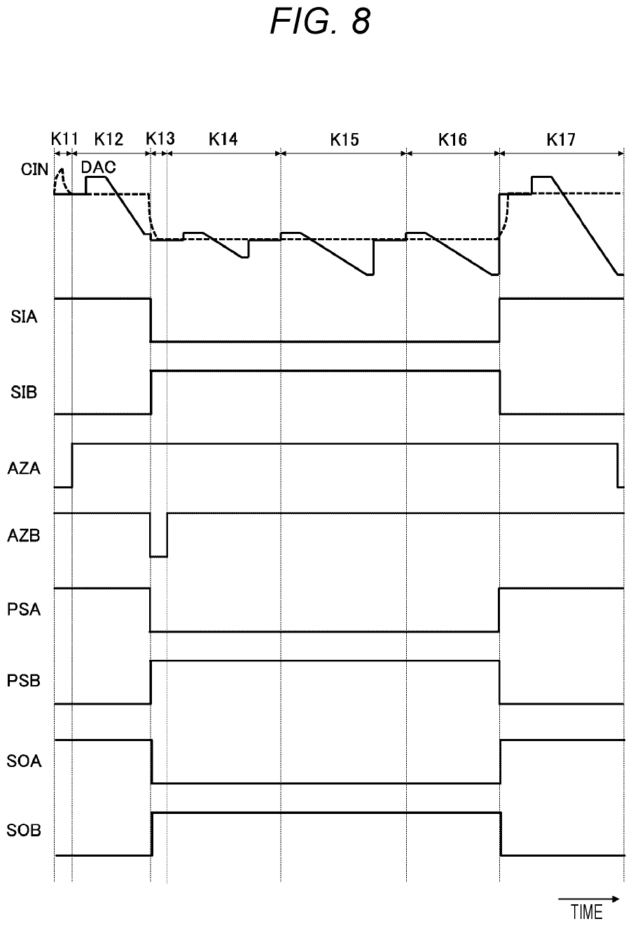

FIG. 8 is a timing chart illustrating waveforms of each section while the comparator according to the first embodiment is in operation. Note that FIG. 8 illustrates an example in which high-gain input D-phase AD conversion is performed twice; however, the high-gain input D-phase AD conversion may be performed only once. Phase difference information can be acquired by performing the high-gain input D-phase AD conversion twice. This phase difference information can be used for autofocus.

In FIG. 8, during a low-gain auto-zero period K11, the input switching signal SIA, the auto-zero signal AZB, the off-leak signal PSA, and the output switching signal SOA are set to the high level. Furthermore, the input switching signal SIB, the auto-zero signal AZA, the off-leak signal PSB, and the output switching signal SOB are set to the low level. At this time, the switches 217A, 214A, 213B, and 215A are turned on, and the switches 217B, 214B, 213A, and 215B are turned off. Therefore, charge is accumulated in the capacitor 216A to balance low-gain differential input. Here, the voltage between the source and drain of the P-channel field effect transistor 212B is set to zero via the switch 213B, and the leakage current flowing through the P-channel field effect transistor 212B is reduced. Upon completion of the low-gain auto-zero period K11, the processing proceeds to a low-gain input P-phase AD conversion period K12.

During the low-gain input P-phase AD conversion period K12, the input switching signal SIA, the auto-zero signals AZA and AZB, the off-leak signal PSA, and the output switching signal SOA are set to the high level. Furthermore, the input switching signal SIB, the off-leak signal PSB, and the output switching signal SOB are set to the low level. At this time, the switches 217A, 213B, and 215A are turned on, and the switches 217B, 214A, 214B, 213A, and 215B are turned off. Here, a low-gain P-phase pixel signal read out from the pixel PIX2 is input as the input signal CIN to the gate of the P-channel field effect transistor 212A via the switch 217A and the capacitor 216A. Furthermore, as the reference signal DAC, a ramp wave is input to the gate of the P-channel field effect transistor 211. Then, the low-gain P-phase pixel signal read out from the pixel PIX2 is compared with the reference signal DAC, and the low-gain P-phase pixel signal is subjected to AD conversion on the basis of counting operation until the level of the low-gain P-phase pixel signal matches the level of the reference signal DAC. Here, the voltage between the source and drain of the P-channel field effect transistor 212B is set to zero via the switch 213B, and the leakage current flowing through the P-channel field effect transistor 212B is reduced. Upon completion of the low-gain input P-phase AD conversion period K12, the processing proceeds to a high-gain auto-zero period K13.

During the high-gain auto-zero period K13, the input switching signal SIB, the auto-zero signal AZA, the off-leak signal PSB, and the output switching signal SOB are set to the high level. Furthermore, the input switching signal SIA, the auto-zero signal AZB, the off-leak signal PSA, and the output switching signal SOA are set to the low level. At this time, the switches 217B, 214B, 213A, and 215B are turned on, and the switches 217A, 214A, 213B, and 215A are turned off. Therefore, charge is accumulated in the capacitor 216B to balance high-gain differential input. Here, the voltage between the source and drain of the P-channel field effect transistor 212A is set to zero via the switch 213A, and the leakage current flowing through the P-channel field effect transistor 212A is reduced. Upon completion of the high-gain auto-zero period K13, the processing proceeds to a high-gain input P-phase AD conversion period K14.

During the high-gain input P-phase AD conversion period K14, the input switching signal SIB, the auto-zero signals AZA and AZB, the off-leak signal PSB, and the output switching signal SOB are set to the high level. Furthermore, the input switching signal SIA, the off-leak signal PSA, and the output switching signal SOA are set to the low level. At this time, the switches 217B, 214B, and 215B are turned on, and the switches 217A, 214A, 213A, 213B, and 215A are turned off. Here, a high-gain P-phase pixel signal read out from the pixel PIX2 is input as the input signal CIN to the gate of the P-channel field effect transistor 212B via the switch 217B and the capacitor 216B. Furthermore, as the reference signal DAC, a ramp wave is input to the gate of the P-channel field effect transistor 211. Then, the high-gain P-phase pixel signal read out from the pixel PIX2 is compared with the reference signal DAC, and the high-gain P-phase pixel signal is subjected to AD conversion on the basis of counting operation until the level of the high-gain P-phase pixel signal matches the level of the reference signal DAC. Here, the voltage between the source and drain of the P-channel field effect transistor 212A is set to zero via the switch 213A, and the leakage current flowing through the P-channel field effect transistor 212A is reduced. Upon completion of the high-gain input P-phase AD conversion period K14, the processing proceeds to a high-gain input D1-phase AD conversion period K15. Upon completion of the high-gain input D1-phase AD conversion period K15, the processing proceeds to a high-gain input D2-phase AD conversion period K16.

During the high-gain input D1-phase AD conversion period K15 and the high-gain input D2-phase AD conversion period K16, the input switching signal SIB, the auto-zero signals AZA and AZB, the off-leak signal PSB, and the output switching signal SOB are set to the high level. Furthermore, the input switching signal SIA, the off-leak signal PSA, and the output switching signal SOA are set to the low level. At this time, the switches 217B, 214B, and 215B are turned on, and the switches 217A, 214A, 213A, 213B, and 215A are turned off. Here, a high-gain D-phase pixel signal read out from the pixel PIX2 is input as the input signal CIN to the gate of the P-channel field effect transistor 212B via the switch 217B and the capacitor 216B. Furthermore, as the reference signal DAC, a ramp wave is input to the gate of the P-channel field effect transistor 211. Then, the high-gain D-phase pixel signal read out from the pixel PIX2 is compared with the reference signal DAC, and the high-gain D-phase pixel signal is subjected to AD conversion on the basis of counting operation until the level of the high-gain D-phase pixel signal matches the level of the reference signal DAC. Here, the voltage between the source and drain of the P-channel field effect transistor 212A is set to zero via the switch 213A, and the leakage current flowing through the P-channel field effect transistor 212A is reduced. Upon completion of the high-gain input D2-phase AD conversion period K16, the processing proceeds to a low-gain input D-phase AD conversion period K17.

During the low-gain input D-phase AD conversion period K17, the input switching signal SIA, the auto-zero signals AZA and AZB, the off-leak signal PSA, and the output switching signal SOA are set to the high level. Furthermore, the input switching signal SIB, the off-leak signal PSB, and the output switching signal SOB are set to the low level. At this time, the switches 217A, 213B, and 215A are turned on, and the switches 217B, 214A, 214B, 213A, and 215B are turned off. Here, a low-gain D-phase pixel signal read out from the pixel PIX2 is input as the input signal CIN to the gate of the P-channel field effect transistor 212A via the switch 217A and the capacitor 216A. Furthermore, as the reference signal DAC, a ramp wave is input to the gate of the P-channel field effect transistor 211. Then, the low-gain D-phase pixel signal read out from the pixel PIX2 is compared with the reference signal DAC, and the low-gain D-phase pixel signal is subjected to AD conversion on the basis of counting operation until the level of the low-gain D-phase pixel signal matches the level of the reference signal DAC. Here, the voltage between the source and drain of the P-channel field effect transistor 212B is set to zero via the switch 213B, and the leakage current flowing through the P-channel field effect transistor 212B is reduced.

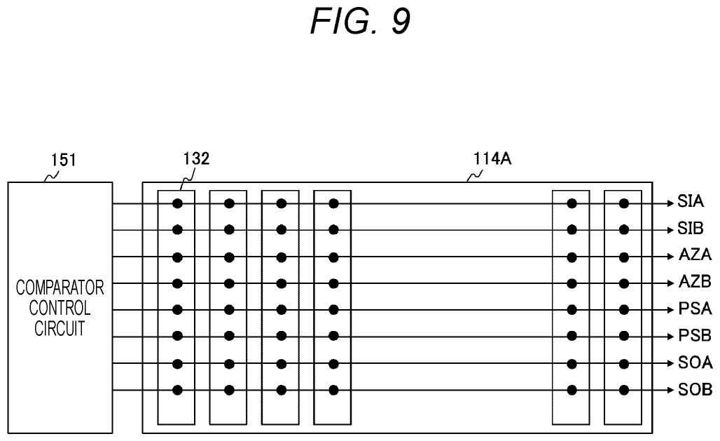

FIG. 9 is a block diagram illustrating an example of a control signal system of a column ADC circuit according to the first embodiment.

In FIG. 9, the comparator 132 is provided for each column in the column ADC unit 114A. The input switching signals SIA and SIB, the off-leak signals PSA and PSB, the auto-zero signals AZA and AZB, and the output switching signals SOA and SOB are input to each comparator 132 from a comparator control circuit 151.

As described above, in the first embodiment, the switches 213A and 213B are connected in parallel with the P-channel field effect transistors 212A and 212B used as input transistors, respectively, in the P-channel two-input single-ended auto-zero comparator. This configuration allows the source-drain voltage of the input transistor not used for AD conversion to be fixed the tail voltage while enabling the switching of the input transistor used for AD conversion. It is therefore possible to stabilize the source-drain voltage of the input transistor not used for AD conversion and reduce the leakage current flowing through the input transistor not used for AD conversion. As a result, vertical streaks and shading caused by variations in leakage current for each column can be suppressed, and the dynamic range can be enhanced while suppressing degradation in image quality.

Furthermore, each of the switches 213A and 213B can be used for output settling assist that raises the output voltage VO of the comparator to the high level before AD conversion. At this time, each of the switches 213A and 213B can be used for both leakage current prevention and output settling assist. This eliminates the need to provide an output settling assist dedicated switch separately from the switches 213A and 213B, which makes it possible to suppress an increase in the number of comparator elements.

### 2. Second Embodiment

In the first embodiment, the switches 213A and 213B are connected in parallel with the P-channel field effect transistors 212A and 212B used as input transistors, respectively, in the P-channel two-input single-ended auto-zero comparator. In this second embodiment, a switch is connected in parallel with an N-channel field effect transistor used as an input transistor in an N-channel two-input single-ended auto-zero comparator.

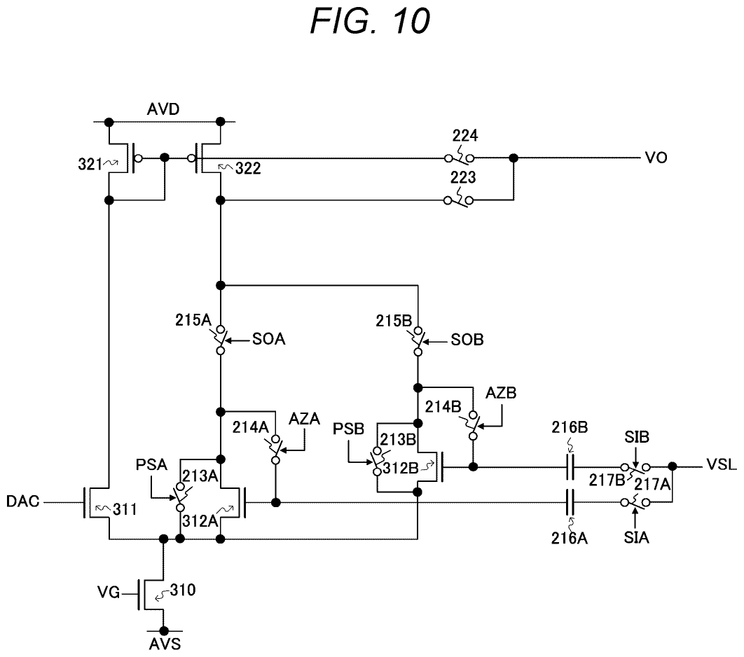

FIG. 10 is a diagram illustrating a configuration example of the comparator according to the second embodiment.

In FIG. 10, this comparator includes, instead of the P-channel field effect transistors 211, 212A, and 212B and the N-channel field effect transistors 221 and 222 of the first embodiment, N-channel field effect transistors 311, 312A, and 312B and P-channel field effect transistors 321 and 322. The other components of the comparator of the second embodiment are similar to those of the comparator of the first embodiment. Note that the N-channel field effect transistors 312A and 312B are examples of the input transistor recited in the claims. The N-channel field effect transistor 311 is an example of the reference transistor recited in the claims.

The N-channel field effect transistor 311 and the P-channel field effect transistor 321 are connected in series with each other. The N-channel field effect transistors 312A and 312B are connected in parallel with each other. The N-channel field effect transistor 312A has its drain connected to the drain of the P-channel field effect transistor 322 via the switch 215A. The N-channel field effect transistor 312B has its drain connected to the drain of the P-channel field effect transistor 322 via the switch 215B. The N-channel field effect transistors 311, 312A, and 312B have their sources connected to the power supply potential AVS via the N-channel field effect transistor 310. The N-channel field effect transistor 312A can be used for the input of the pixel signal read out from pixel PIX2 at low gain. The N-channel field effect transistor 312B can be used for the input of the pixel signal read out from pixel PIX2 at high gain. The bias voltage VG is applied to the gate of the N-channel field effect transistor 310. The N-channel field effect transistor 310 can operate as a constant current source on the basis of the bias voltage VG.

The switch 214A is connected between the gate and drain of the N-channel field effect transistor 312A. The switch 214B is connected between the gate and drain of the N-channel field effect transistor 312B.

The switch 213A is connected in parallel with the N-channel field effect transistor 312A. The switch 213B is connected in parallel with the N-channel field effect transistor 312B.

The switch 217A has its output end connected to the gate of the N-channel field effect transistor 312A via the capacitor 216A. The switch 217B has its output end connected to the gate of the N-channel field effect transistor 312B via the capacitor 216B.

The P-channel field effect transistors 321 and 322 have their sources connected to the power supply potential AVD. The P-channel field effect transistors 321 and 322 have their gates connected to the drain of P-channel field effect transistor 321. At this time, the P-channel field effect transistors 321 and 322 can serve as a current mirror.

The switch 223 has its input end connected to the drain of the P-channel field effect transistor 322. The switch 224 has its input end connected to the gates of the P-channel field effect transistors 321 and 322.

This comparator can operate in a similar manner to the comparator of the first embodiment. At this time, the comparator can operate in accordance with the timing illustrated in FIG. 8.

As described above, in the second embodiment, the switches 213A and 213B are connected in parallel with the N-channel field effect transistors 312A and 312B used as input transistors, respectively, in the N-channel two-input single-ended auto-zero comparator. It is therefore possible to stabilize the source-drain voltage of the input transistor not used for AD conversion while enabling the auto-zeroing of the input transistor and reduce the leakage current flowing through the input transistor not used for AD conversion.

### 3. Third Embodiment

In the first embodiment, the switches 213A and 213B are connected in parallel with the P-channel field effect transistors 212A and 212B used as input transistors, respectively, in the P-channel two-input single-ended auto-zero comparator. In this third embodiment, a switch is connected in parallel with a P-channel field effect transistor used as an input transistor in a P-channel two-input dual-ended auto-zero comparator. Furthermore, a switch is connected in parallel with a P-channel field effect transistor used as a reference transistor.

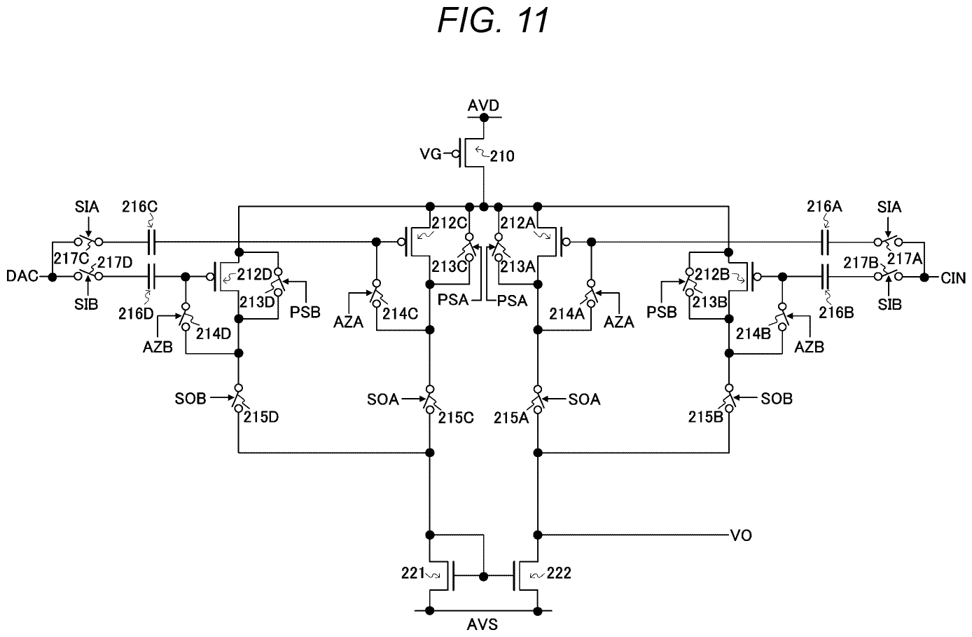

FIG. 11 is a diagram illustrating a configuration example of the comparator according to the third embodiment.

In FIG. 11, this comparator includes P-channel field effect transistors 212C and 212D, instead of the P-channel field effect transistor 211 of the first embodiment. Furthermore, this comparator does not include the switches 223 and 224, compared to the comparator of the first embodiment. Furthermore, this comparator further includes switches 213C, 214C, 215C, 217C, 213D, 214D, 215D, and 217D and capacitors 216C and 216D, compared to the comparator of the first embodiment. These additional components are arranged on the input side of the reference signal DAC. At this time, the input side of the reference signal DAC is configured to be symmetric with the input side of the input signal CIN. The other components of the comparator of the third embodiment are similar to those of the comparator of the first embodiment. Note that the P-channel field effect transistors 212C and 212D are examples of the reference transistor recited in the claims.

This comparator serves as a P-channel two-input dual-ended auto-zero comparator. At this time, the input side of the input signal CIN can be configured in a similar manner to the comparator of the first embodiment described above.

On the input side of the reference signal DAC, the P-channel field effect transistors 212C and 212D are connected in parallel with each other. The P-channel field effect transistor 212C has its drain connected to the drain of the N-channel field effect transistor 221 via the switch 215C. The P-channel field effect transistor 212D has its drain connected to the drain of the N-channel field effect transistor 221 via the switch 215D. The switches 215C and 215D are turned on/off on the basis of the output switching signals SOA and SOB, respectively. The P-channel field effect transistors 212C and 212D have their sources connected to the power supply potential AVD via the P-channel field effect transistor 210. The P-channel field effect transistor 212C can be used for the input of the reference signal DAC to be compared with the pixel signal read out from pixel PIX2 at low gain. The P-channel field effect transistor 212D can be used for the input of the reference signal DAC to be compared with the pixel signal read out from pixel PIX2 at high gain.

The switch 214C is connected between the gate and drain of the P-channel field effect transistor 212C. The switch 214D is connected between the gate and drain of the P-channel field effect transistor 212D. The switches 214C and 214D are turned on/off on the basis of the auto-zero signals AZA and AZB, respectively. At this time, when the switch 214C is turned on, the switch 213C is turned off, and the switch 213D is turned on. When the switch 214D is turned on, the switch 213C is turned on, and the switch 213D is turned off. Note that the switches 214C and 214D are examples of the auto-zero switch recited in the claims.

The switch 213C can prevent the leakage current from flowing through the P-channel field effect transistor 212C deactivated on the basis of the switching of the P-channel field effect transistor 212C. The switch 213C is connected in parallel with the P-channel field effect transistor 212C. The switch 213D can prevent the leakage current from flowing through the P-channel field effect transistor 212D deactivated on the basis of the switching of the P-channel field effect transistor 212D. The switch 213D is connected in parallel with the P-channel field effect transistor 212D. The switches 213C and 213D are turned on/off on the basis of the off-leak signals PSA and PSB, respectively. At this time, when the input signal CIN is switched to the P-channel field effect transistor 212C, the switch 213C is turned off, and the switch 213D is turned on. When the input signal CIN is switched to the P-channel field effect transistor 212D, the switch 213C is turned on, and the switch 213D is turned off.

The switches 217C and 217D have their input ends connected together, and the reference signal DAC is input to the input ends of the switches 217C and 217D. The switch 217C has its output end connected to the gate of the P-channel field effect transistor 212C via the capacitor 216C. The switch 217D has its output end connected to the gate of the P-channel field effect transistor 212D via the capacitor 216D. The switches 217C and 217D are turned on/off on the basis of the input switching signals SIA and SIB, respectively. The output voltage VO of the comparator is output from the drain of the N-channel field effect transistor 222.

This comparator can operate in a similar manner to the comparator of the first embodiment. At this time, the comparator can operate in accordance with the timing illustrated in FIG. 8.

As described above, in the third embodiment, the switches 213A and 213B are connected in parallel with the P-channel field effect transistors 212A and 212B used as input transistors, respectively, in the P-channel two-input dual-ended auto-zero comparator. Furthermore, the switches 213C and 213D are connected in parallel with the P-channel field effect transistors 212C and 212D used as reference transistors. It is therefore possible to reduce the leakage current flowing through the input transistor and reference transistor not used for AD conversion while enabling the auto-zeroing of the input transistor and reference transistor.

### 4. Fourth Embodiment

In the third embodiment, the switch is connected in parallel with each P-channel field effect transistor used as an input transistor and a reference transistor in the P-channel two-input dual-ended auto-zero comparator. In this fourth embodiment, a switch is connected in parallel with each N-channel field effect transistor used as an input transistor and a reference transistor in an N-channel two-input dual-ended auto-zero comparator.

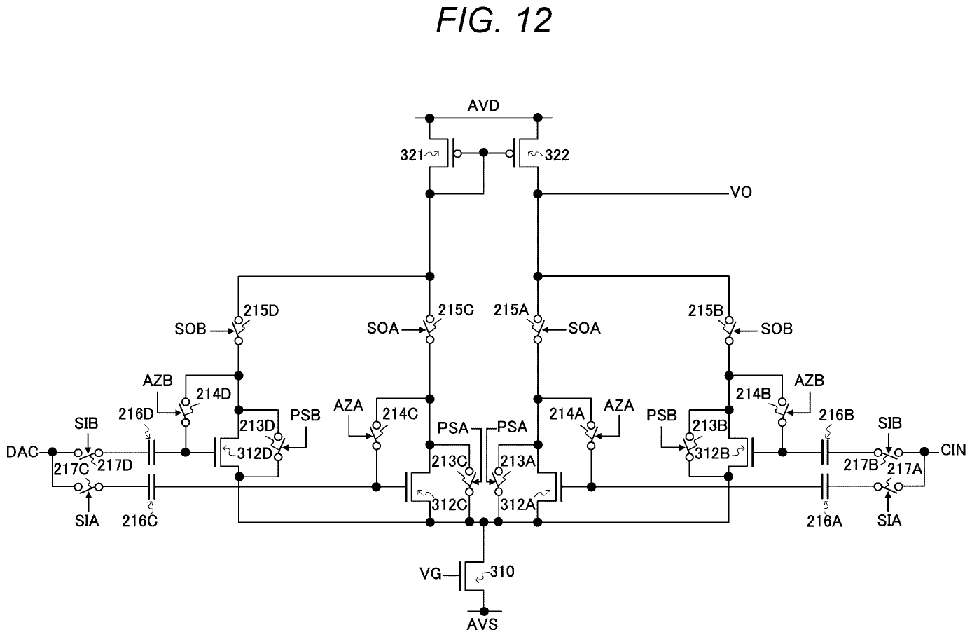

FIG. 12 is a diagram illustrating a configuration example of the comparator according to the fourth embodiment.

In FIG. 12, this comparator includes, instead of the P-channel field effect transistors 210, 212A, 212B, 212C, and 212D and the N-channel field effect transistors 221 and 222 of the third embodiment, N-channel field effect transistors 310, 312A, 312B, 312C, and 312D and P-channel field effect transistors 321 and 322. The other components of the comparator of the fourth embodiment are similar to those of the comparator of the third embodiment. Note that the N-channel field effect transistors 312C and 312D are examples of the reference transistor recited in the claims.

This comparator serves as an N-channel two-input dual-ended auto-zero comparator. At this time, the input side of the input signal CIN can be configured in a similar manner to the comparator of the second embodiment.

On the input side of the reference signal DAC, the N-channel field effect transistors 312C and 312D are connected in parallel with each other. The N-channel field effect transistor 312C has its drain connected to the drain of the P-channel field effect transistor 321 via the switch 215C. The N-channel field effect transistor 312D has its drain connected to the drain of the P-channel field effect transistor 321 via the switch 215D. The N-channel field effect transistors 312C and 312D have their sources connected to the power supply potential AVS via the N-channel field effect transistor 310. The N-channel field effect transistor 312C can be used for the input of the reference signal DAC to be compared with the pixel signal read out from pixel PIX2 at low gain. The N-channel field effect transistor 312D can be used for the input of the reference signal DAC to be compared with the pixel signal read out from pixel PIX2 at high gain.

The switch 214C is connected between the gate and drain of the N-channel field effect transistor 312C. The switch 214D is connected between the gate and drain of the N-channel field effect transistor 312D.

The switch 213C is connected in parallel with the N-channel field effect transistor 312C. The switch 213D is connected in parallel with the N-channel field effect transistor 312D.

The switch 217C has its output end connected to the gate of the N-channel field effect transistor 312C via the capacitor 216C. The switch 217D has its output end connected to the gate of the N-channel field effect transistor 312D via the capacitor 216D. The output voltage VO of the comparator is output from the drain of the P-channel field effect transistor 322.

This comparator can operate in a similar manner to the comparator of the first embodiment. At this time, the comparator can operate in accordance with the timing illustrated in FIG. 8.

As described above, in the fourth embodiment, the switches 213A and 213B are connected in parallel with the N-channel field effect transistors 312A and 312B used as input transistors, respectively, in the N-channel two-input dual-ended auto-zero comparator. Furthermore, the switches 213C and 213D are connected in parallel with the N-channel field effect transistors 312C and 312D used as reference transistors. It is therefore possible to reduce the leakage current flowing through the input transistor and reference transistor not used for AD conversion while enabling the auto-zeroing of the input transistor and reference transistor.

### 5. Fifth Embodiment

In the first embodiment, the switches 213A and 213B are connected in parallel with the P-channel field effect transistors 212A and 212B used as input transistors, respectively, in the P-channel two-input single-ended auto-zero comparator. In this fifth embodiment, the switch 213A is connected in parallel with the P-channel field effect transistor 212A used as an input transistor in the P-channel one-input single-ended auto-zero comparator.

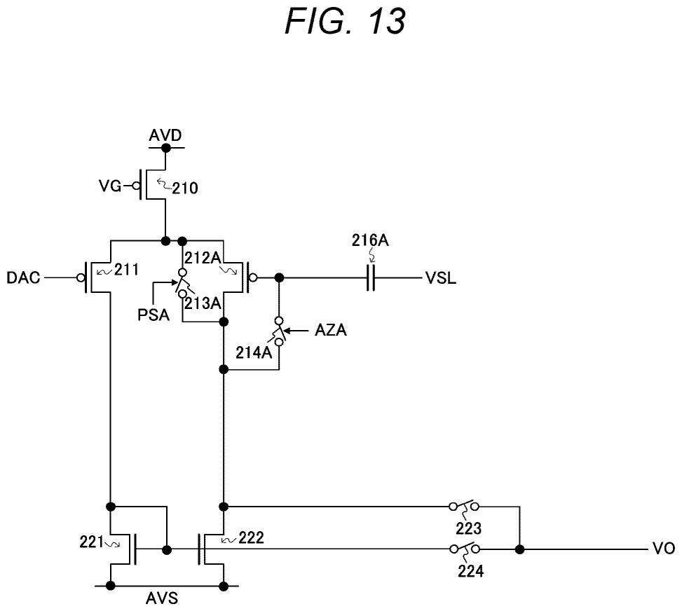

FIG. 13 is a diagram illustrating a configuration example of the comparator according to the fifth embodiment.

In FIG. 13, this comparator does not include the P-channel field effect transistor 212B, the capacitor 216B, and the switches 215A, 213B, 214B, 215B, 217A, and 217B, compared to the comparator of the first embodiment. At this time, the P-channel field effect transistor 212A and the N-channel field effect transistor 222 are connected in series with each other. The other components of the comparator of the fifth embodiment are similar to those of the comparator of the first embodiment.

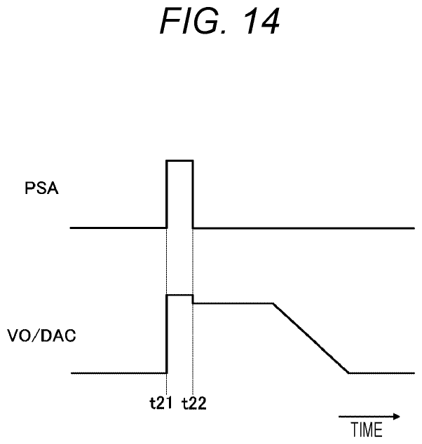

FIG. 14 is a timing chart illustrating waveforms of each section while the comparator according to the fifth embodiment is in operation.

In FIG. 14, before AD conversion, when the off-leak signal PSA rises (t21), the source-drain voltage of the P-channel field effect transistor 212A becomes zero. At this time, the output voltage VO of the comparator is raised to the high level. Then, when the off-leak signal PSA falls (t22), a ramp wave is supplied as the reference signal DAC, and AD conversion begins.

As described above, in the fifth embodiment, the switch 213A is connected in parallel with the P-channel field effect transistor 212A used as an input transistor in the P-channel one-input single-ended auto-zero comparator. The switch 213A can be used for output settling assist. At this time, the output voltage VO of the comparator can be raised to the high level by turning on the switch 213A before AD conversion.

### 6. Sixth Embodiment

As described above, in the first embodiment, the switch 213A is connected in parallel with the P-channel field effect transistor 212A used as an input transistor in the P-channel one-input single-ended auto-zero comparator. In this sixth embodiment, the switch 213A is connected in parallel with the N-channel field effect transistor 312A used as an input transistor in the N-channel one-input single-ended auto-zero comparator.

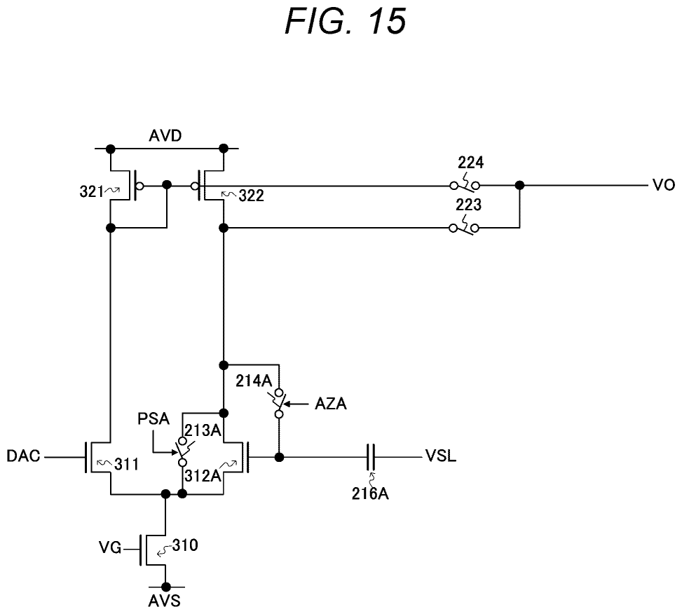

FIG. 15 is a diagram illustrating a configuration example of the comparator according to the sixth embodiment.

In FIG. 15, this comparator does not include the N-channel field effect transistor 312B, the capacitor 216B, and the switches 215A, 213B, 214B, 215B, 217A, and 217B, compared to the comparator of the second embodiment. At this time, the N-channel field effect transistor 312A and the P-channel field effect transistor 322 are connected in series with each other. The other components of the comparator of the fifth embodiment are similar to those of the comparator of the second embodiment.

This comparator can operate in a similar manner to the comparator of the fifth embodiment. At this time, the comparator can operate in accordance with the timing illustrated in FIG. 14. However, in this comparator, an inverted ramp wave can be supplied as the reference signal DAC.

As described above, in the sixth embodiment, the switch 213A is connected in parallel with the N-channel field effect transistor 312A used as an input transistor in the N-channel one-input single-ended auto-zero comparator. It is therefore possible to raise the switch 213A to the output settling assist and lower the output voltage VO of the comparator to the low level before AD conversion.

### 7. Seventh Embodiment

In the first embodiment, the switch is connected in parallel with the input transistor in the P-channel two-input single-ended auto-zero comparator. In this seventh embodiment, a switch is connected in series with the source of an input transistor in a P-channel two-input single-ended auto-zero comparator.

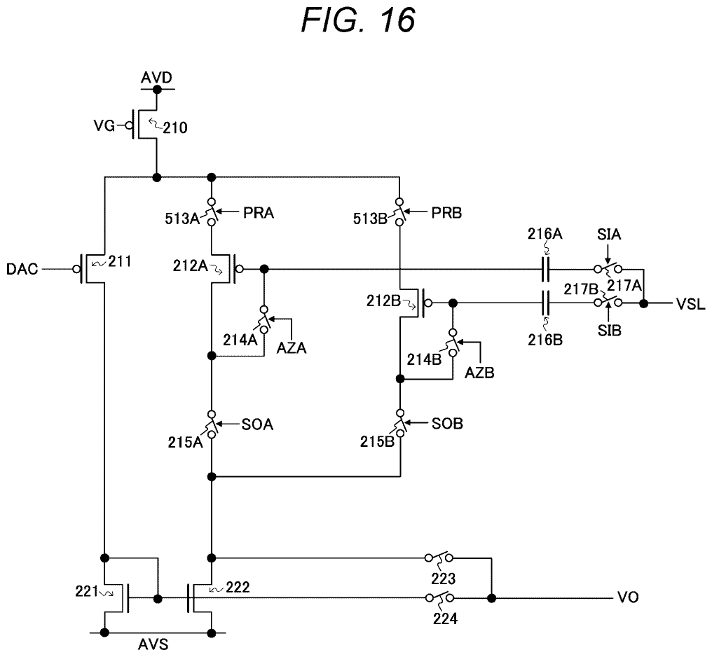

FIG. 16 is a diagram illustrating a configuration example of the comparator according to the seventh embodiment.

In FIG. 16, this comparator includes switches 513A and 513B, instead of the switches 213A and 213B of the first embodiment. The other components of the comparator of the seventh embodiment are similar to those of the comparator of the first embodiment.

The switch 513A is connected in series with the source of the P-channel field effect transistor 212A. The switch 513B is connected in series with the source of the P-channel field effect transistor 212B. The switches 513A and 513B are turned on/off on the basis of the off-leak signals PRA and PRB, respectively. At this time, when the P-channel field effect transistor 212A is used for AD conversion and the P-channel field effect transistor 212B is not used for AD conversion, the switch 513A is turned on, and the switch 513B is turned off. At this time, when the P-channel field effect transistor 212B is used for AD conversion and the P-channel field effect transistor 212A is not used for AD conversion, the switch 513B is turned on, and the switch 513A is turned off.

As described above, in the seventh embodiment, the switches 513A and 513B are connected in series with the sources of the P-channel field effect transistors 212A and 212B used as input transistors, respectively, in the P-channel two-input single-ended auto-zero comparator. It is therefore possible to stabilize the source-drain voltage of the input transistor not used for AD conversion while enabling the auto-zeroing of the input transistor and reduce the leakage current flowing through the input transistor not used for AD conversion.

Note that, in the seventh embodiment, the switch is connected in series with the source of the input transistor in the P-channel two-input single-ended auto-zero comparator. This configuration may be applied to an N-channel two-input single-ended auto-zero comparator, may be applied to a P-channel two-input dual-ended auto-zero comparator, or may be applied to an N-channel two-input dual-ended auto-zero comparator.

### 8. Eighth Embodiment

In the first embodiment, the switch is connected in parallel with the input transistor in the P-channel two-input single-ended auto-zero comparator. In this eighth embodiment, a switch is connected between the gate and source of an input transistor in a P-channel two-input single-ended auto-zero comparator.

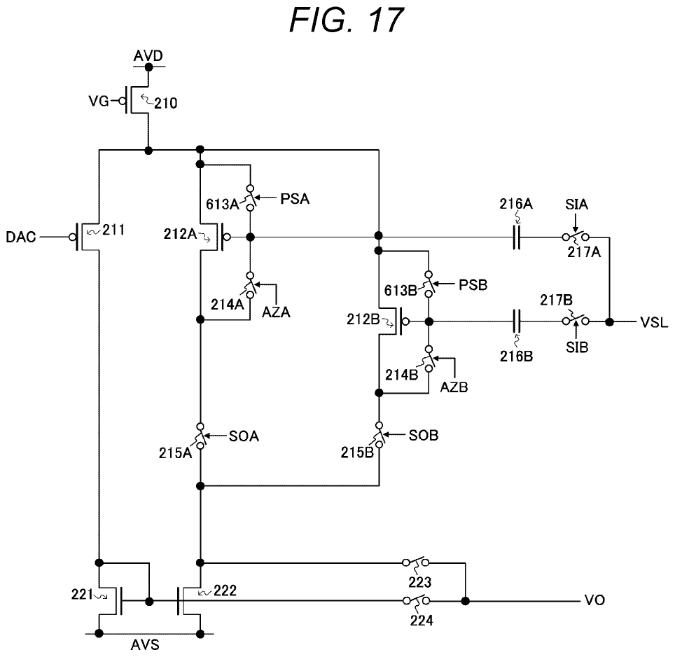

FIG. 17 is a diagram illustrating a configuration example of the comparator according to the eighth embodiment.

In FIG. 17, this comparator includes switches 613A and 613B, instead of the switches 213A and 213B of the first embodiment. The other components of the comparator of the eighth embodiment are similar to those of the comparator of the first embodiment.

The switch 613A is connected between the gate and source of the P-channel field effect transistor 212A. The switch 613B is connected between the gate and source of the P-channel field effect transistor 212B.

This comparator can operate in a similar manner to the comparator of the first embodiment. At this time, the comparator can operate in accordance with the timing illustrated in FIG. 8.

As described above, in the eighth embodiment, the switches 613A and 613B are connected between the gates and sources of the P-channel field effect transistors 212A and 212B used as input transistors, respectively, in the P-channel two-input single-ended auto-zero comparator. It is therefore possible to stabilize the source-drain voltage of the input transistor not used for AD conversion while enabling the auto-zeroing of the input transistor and reduce the leakage current flowing through the input transistor not used for AD conversion.

Note that, in the eighth embodiment, the switch is connected in series with the source of the input transistor in the P-channel two-input single-ended auto-zero comparator. This configuration may be applied to an N-channel two-input single-ended auto-zero comparator, may be applied to a P-channel two-input dual-ended auto-zero comparator, or may be applied to an N-channel two-input dual-ended auto-zero comparator.

### 9. Ninth Embodiment

In the first embodiment, the switch is connected in parallel with the input transistor in the P-channel two-input single-ended auto-zero comparator. In this ninth embodiment, a switch that pulls down the gate of an input transistor is provided in a P-channel two-input single-ended auto-zero comparator.

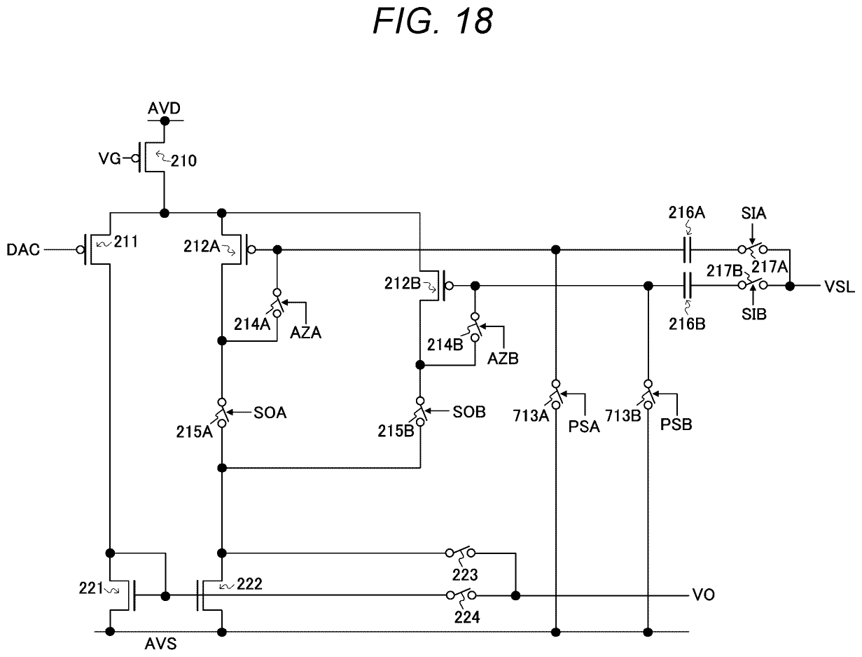

FIG. 18 is a diagram illustrating a configuration example of the comparator according to the ninth embodiment.

In FIG. 18, this comparator includes switches 713A and 713B, instead of the switches 213A and 213B of the first embodiment. The other components of the comparator of the eighth embodiment are similar to those of the comparator of the first embodiment.

The switch 713A is connected between the gate of the P-channel field effect transistor 212A and the power supply potential AVS. The switch 713B is connected between the gate of the P-channel field effect transistor 212B and the power supply potential AVS. The switches 713A and 713B can pull down the gates of the P-channel field effect transistors 212A and 212B, respectively.

This comparator can operate in a similar manner to the comparator of the first embodiment. At this time, the comparator can operate in accordance with the timing illustrated in FIG. 8.

As described above, in the ninth embodiment, the switches 713A and 713B are connected between the gates of the P-channel field effect transistors 212A and 212B used as input transistors and the power supply potential AVS, respectively, in the P-channel two-input single-ended auto-zero comparator. It is therefore possible to stabilize the source-drain voltage of the input transistor not used for AD conversion while enabling the auto-zeroing of the input transistor and reduce the leakage current flowing through the input transistor not used for AD conversion.

Note that, in the ninth embodiment, the switch is connected in series with the source of the input transistor in the P-channel two-input single-ended auto-zero comparator. This configuration may be applied to an N-channel two-input single-ended auto-zero comparator, may be applied to a P-channel two-input dual-ended auto-zero comparator, or may be applied to an N-channel two-input dual-ended auto-zero comparator.

### 10. Tenth Embodiment

In the first embodiment, the switch is connected in parallel with the input transistor in the P-channel two-input single-ended auto-zero comparator. In this tenth embodiment, a switch that connects the drain of an input transistor to fixed potential is provided in a P-channel two-input single-ended auto-zero comparator.

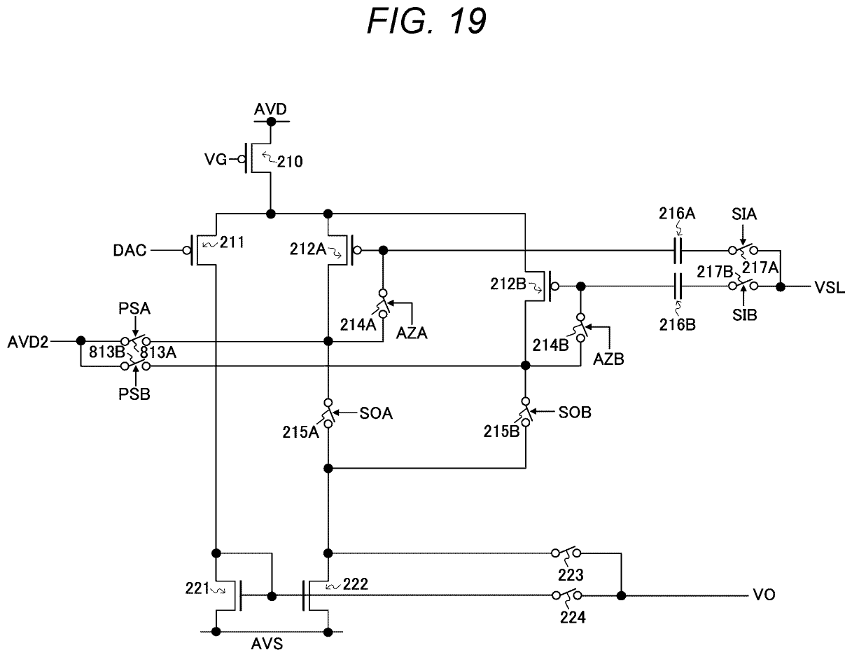

FIG. 19 is a diagram illustrating a configuration example of the comparator according to the tenth embodiment.

In FIG. 19, this comparator includes switches 813A and 813B instead of the switches 213A and 213B of the first embodiment described above. The other components of the comparator of the tenth embodiment are similar to those of the comparator of the first embodiment.

The switch 813A is connected between the drain of the P-channel field effect transistor 212A and the fixed potential AVD2. The switch 813B is connected between the drain of the P-channel field effect transistor 212B and the fixed potential AVD2. The fixed potential AVD2 can be set to any potential.

This comparator can operate in a similar manner to the comparator of the first embodiment. At this time, the comparator can operate in accordance with the timing illustrated in FIG. 8.

As described above, in the tenth embodiment, the switches 813A and 813B are connected between the drains of the P-channel field effect transistors 212A and 212B used as input transistors and the fixed potential AVD2, respectively, in the P-channel two-input single-ended auto-zero comparator. It is therefore possible to stabilize the source-drain voltage of the input transistor not used for AD conversion while enabling the auto-zeroing of the input transistor and reduce the leakage current flowing through the input transistor not used for AD conversion.

Note that, in the tenth embodiment, the switch is connected in series with the source of the input transistor in the P-channel two-input single-ended auto-zero comparator. This configuration may be applied to an N-channel two-input single-ended auto-zero comparator, may be applied to a P-channel two-input dual-ended auto-zero comparator, or may be applied to an N-channel two-input dual-ended auto-zero comparator.

### 11. Eleventh Embodiment

In the first embodiment, the switch is connected in parallel with the input transistor in the P-channel two-input single-ended auto-zero comparator. In this eleventh embodiment, semiconductor chips are stacked to form a solid-state imaging device provided with a pixel array unit in which pixels are arranged in a matrix.

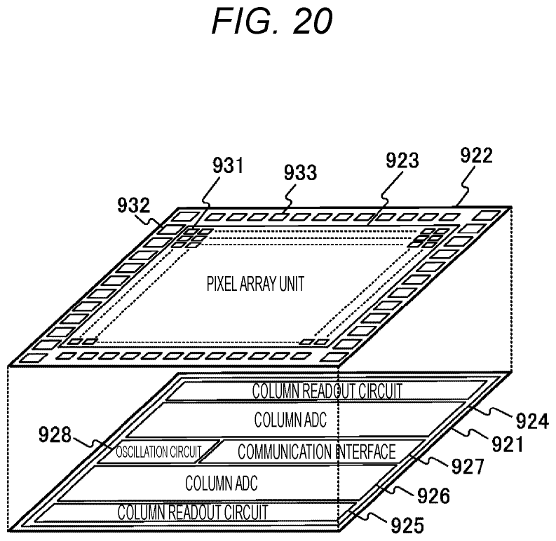

FIG. 20 is a perspective view illustrating an example of a multi-layer structure of the solid-state imaging device according to the eleventh embodiment.

In FIG. 20, the solid-state imaging device includes semiconductor chips 921 and 922. The semiconductor chip 922 is stacked on the semiconductor chip 921.

A pixel array unit 923 is formed on the semiconductor chip 922. The pixel array unit 923 includes pixels 931 arranged in a matrix in the row direction and column direction. The pixel 931 may be the pixel PIX illustrated in FIG. 3 or the pixel PIX2 illustrated in FIG. 4. Pad electrodes 932 and via electrodes 933 are formed around the pixel array unit 923. The via electrodes 933 penetrate the semiconductor chip 922 and can electrically connect the semiconductor chips 921 and 922 together.

Peripheral circuits 924 are formed on the semiconductor chip 921. In the peripheral circuits 924, a column readout circuit 925, a column ADC 926, a communication interface 927, and an oscillation circuit 928 are formed. The column readout circuit 925 and the column ADC 926 may be formed in such a way as to correspond to positions on both sides of the pixel array unit 923 in the column direction. The column ADC 926 can be provided with the comparator according to any one of the first to tenth embodiments for each column.

As described above, in the eleventh embodiment, the semiconductor chip 922 on which the pixel array unit 923 is formed is stacked on the semiconductor chip 921 on which the peripheral circuit 924 is formed. This configuration can increase sensitivity of the solid-state imaging device while suppressing an increase in mounting area of the semiconductor chip on which the solid-state imaging device is formed.

In the embodiment described above, an example has been described in which the switch that prevents leakage current from flowing through an input transistor deactivated on the basis of the switching of the input transistor is applied to a two-input auto-zero comparator. The switch that prevent leakage current from flowing through an input transistor deactivated on the basis of the switching of the input transistor may be applied to an N-input auto-zero comparator (where N is an integer greater than or equal to 3).

### 12. Application Example for Mobile Body

The technology according to the present disclosure (present technology) can be applied to various products. For example, the technology according to the present disclosure may also be implemented as a device mounted on any type of mobile body such as an automobile, an electric vehicle, a hybrid electric vehicle, a motorcycle, a bicycle, a personal mobility, an airplane, a drone, a vessel, or a robot.

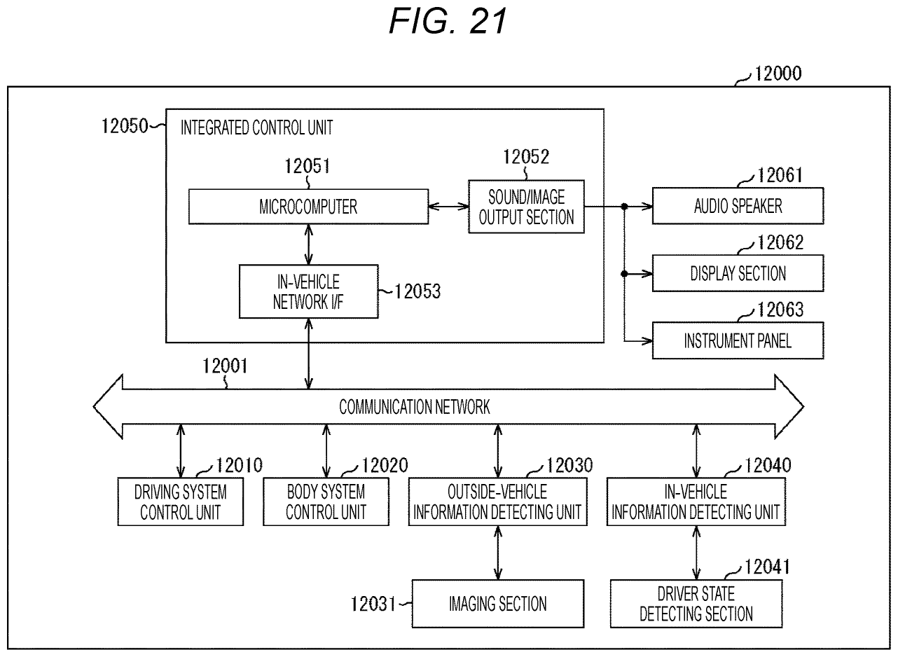

FIG. 21 is a block diagram illustrating a schematic configuration example of a vehicle control system as an example of a mobile body control system to which the technology according to the present disclosure can be applied.

The vehicle control system 12000 includes a plurality of electronic control units connected to each other via a communication network 12001. In the example illustrated in FIG. 21, the vehicle control system 12000 includes a driving system control unit 12010, a body system control unit 12020, an outside-vehicle information detecting unit 12030, an in-vehicle information detecting unit 12040, and an integrated control unit 12050. Furthermore, a microcomputer 12051, a sound/image output section 12052, and an in-vehicle network interface (I/F) 12053 are illustrated as functional components of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light.

The imaging section 12031 can output the electric signal as an image, or can output the electric signal as information about a measured distance. Furthermore, the light received by the imaging section 12031 may be visible light, or may be invisible light such as infrared rays.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

Furthermore, the microcomputer 12051 can output a control command to the body system control unit 12020, on the basis of the information about the outside of the vehicle obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example in FIG. 21, an audio speaker 12061, a display section 12062, and an instrument panel 12063 are illustrated as examples of the output device. The display section 12062 may, for example, include at least one of an on-board display and a head-up display.

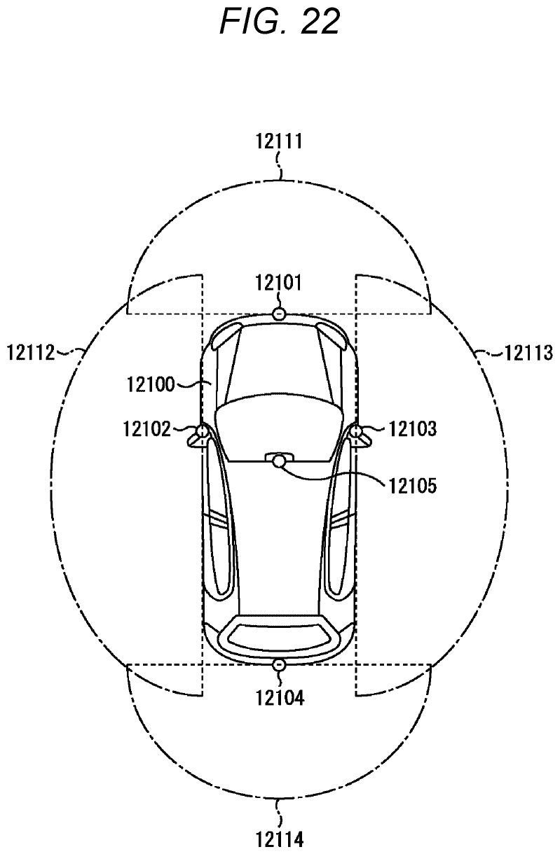

FIG. 22 is a view illustrating an example of a position where the imaging section 12031 is provided.

In FIG. 22, the imaging section 12031 includes imaging sections 12101, 12102, 12103, 12104, and 12105.

The imaging sections 12101, 12102, 12103, 12104, 12105 are provided, for example, at positions such as a front nose, sideview mirrors, a rear bumper, a back door, and an upper portion of a windshield within the interior of a vehicle 12100. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly images of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Note that FIG. 22 illustrates an example of imaging ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology of the present disclosure can be applied to, for example, the imaging section 12031 among the components described above. Specifically, for example, the comparators of the first to tenth embodiments described above can be applied to, for example, the imaging section 12031. By applying the technology according to the present disclosure to the vehicle control system 12000, it is possible to switch gain while reducing the leakage current flowing through the imaging section 12031, and it is possible to enhance dynamic range while suppressing degradation in image quality of the imaging section 12031.

Note that the embodiments described above are examples for embodying the present technology, and the matters in the embodiments and the matters specifying the invention in the claims have correspondence relationships. Similarly, the matters specifying the invention in the claims and matters with the same names in the embodiments of the present technology have correspondence relationships. The present technology, however, is not limited to the embodiments, and can be embodies by making various modifications to the embodiments without departing from the scope of the present technology. Furthermore, the effects described in the present specification are merely examples and not limited, and other effects may be provided.

Note that, the present technology may also have the following configurations.

(1) A comparator including:
a comparison unit that switches a plurality of input transistors to which an input signal is input and compares the input signal with a reference signal; and
a switch that prevents leakage current from flowing through an input transistor deactivated on the basis of the switching of the input transistors.

(2) The comparator according to the above (1), in which
the comparison unit includes:
   a first input transistor to which the input signal is input;
   a second input transistor to which the input signal is input; and
   a reference transistor to which the reference signal is input, and
the switch includes:
   a first switch connected in parallel with the first input transistor; and
   a second switch connected in parallel with the second input transistor.

(3) The comparator according to the above (2), in which
when the input signal is switched to the first input transistor, the first switch is turned off, and the second switch is turned on, and
when the input signal is switched to the second input transistor, the first switch is turned on, and the second switch is turned off.

(4) The comparator according to the above (2) or (3), further including:
a first capacitor connected in series with a gate of the first input transistor;
a second capacitor connected in series with a gate of the second input transistor;
a first auto-zero switch connected between the gate and a drain of the first input transistor; and
a second auto-zero switch connected between the gate and a drain of the second input transistor.

(5) The comparator according to the above (4), in which
when the first auto-zero switch is turned on, the first switch is turned off, and the second switch is turned on, and
when the second auto-zero switch is turned on, the first switch is turned on, and the second switch is turned off.

(6) The comparator according to the above (1), in which
the comparison unit includes:
   a first input transistor to which the input signal is input;
   a second input transistor to which the input signal is input;
   a first reference transistor to which the reference signal is input; and
   a second reference transistor to which the reference signal is input, and
the switch includes:
   a first switch connected in parallel with the first input transistor;
   a second switch connected in parallel with the second input transistor;
   a third switch connected in parallel with the first reference transistor; and
   a fourth switch connected in parallel with the second reference transistor.

(7) The comparator according to the above (6), in which
when the input signal is switched to the first input transistor and the reference signal is switched to the first reference transistor, the first switch and the third switch are turned off, and the second switch and the fourth switch are turned on, and
when the input signal is switched to the second input transistor and the reference signal is switched to the second reference transistor, the first switch and the third switch are turned on, and the second switch and the fourth switch are turned off.

(8) The comparator according to the above (1), in which
the comparison unit includes:
   a first input transistor to which the input signal is input;
   a second input transistor to which the input signal is input; and
   a reference transistor to which the reference signal is input, and
the switch includes:
   a first switch connected in series with a drain of the first input transistor;
   a second switch connected in series with a source of the first input transistor;
   a third switch connected in series with a drain of the second input transistor; and
   a fourth switch connected in series with a source of the second input transistor.

(9) The comparator according to the above (1), in which
the comparison unit includes:
   a first input transistor to which the input signal is input;
   a second input transistor to which the input signal is input; and
   a reference transistor to which the reference signal is input, and
the switch includes:
   a first switch connected between a gate and a drain of the first input transistor;
   a second switch connected between the gate and a source of the first input transistor;
   a third switch connected between a gate and a drain of the second input transistor; and
   a fourth switch connected between the gate and a source of the second input transistor.

(10) The comparator according to the above (1), in which
the comparison unit includes:
   a first input transistor to which the input signal is input;
   a second input transistor to which the input signal is input; and
   a reference transistor to which the reference signal is input, and
the switch includes:
   a first switch that connects a drain of the first input transistor to fixed potential; and
   a second switch that connects a drain of the second input transistor to the fixed potential.

(11) The comparator according to the above (1), in which
the comparison unit includes:
   a first input transistor to which the input signal is input;
   a second input transistor to which the input signal is input; and
   a reference transistor to which the reference signal is input, and
the switch includes:
   a first switch that pulls down a gate of the first input transistor; and
   a second switch that pulls down a gate of the second input transistor.

(12) A comparator including:
a comparison unit that compares an input signal input to an input transistor with a reference signal input to a reference transistor; and
a switch connected in parallel with the input transistor.

(13) An imaging device including:
a pixel array unit in which pixels are arranged in a matrix in a row direction and a column direction; and
a column ADC unit that performs analog to digital (AD) conversion for each column on the basis of a comparison result between a pixel signal read out from the pixels and a reference signal, in which
the column ADC unit includes:
   a comparison unit that switches a plurality of input transistors to which the pixel signal is input and compares the pixel signal with the reference signal; and
   a switch that prevents leakage current from flowing through an input transistor deactivated on the basis of the switching of the input transistors.

(14) The imaging device according to the above (13), in which
the pixel signal includes a first pixel signal and a second pixel signal read out from the pixels at different gains.

(15) The imaging device according to the above (14), in which
the comparison unit includes:
   a first input transistor to which the first pixel signal is input;
   a second input transistor to which the second pixel signal is input; and
   a reference transistor to which the reference signal is input, and
the switch includes:
   a first switch connected in parallel with the first input transistor; and
   a second switch connected in parallel with the second input transistor.

(16) The imaging device according to the above (14), in which
the comparison unit includes:
   a first input transistor to which the first pixel signal is input;
   a second input transistor to which the second pixel signal is input;
   a first reference transistor to which the reference signal is input; and
   a second reference transistor to which the reference signal is input, and
the switch includes:
   a first switch connected in parallel with the first input transistor;
   a second switch connected in parallel with the second input transistor;
   a third switch connected in parallel with the first reference transistor; and
   a fourth switch connected in parallel with the second reference transistor.

(17) The imaging device according to the above (14), in which
the comparison unit includes:
   a first input transistor to which the first pixel signal is input;
   a second input transistor to which the second pixel signal is input; and
   a reference transistor to which the reference signal is input, and
the switch includes:
   a first switch connected in series with a drain of the first input transistor;
   a second switch connected in series with a source of the first input transistor;
   a third switch connected in series with a drain of the second input transistor; and
   a fourth switch connected in series with a source of the second input transistor.

(18) The imaging device according to the above (14), in which
the comparison unit includes:
   a first input transistor to which the first pixel signal is input;
   a second input transistor to which the second pixel signal is input; and
   a reference transistor to which the reference signal is input, and
the switch includes:
   a first switch connected between a gate and a drain of the first input transistor;
   a second switch connected between the gate and a source of the first input transistor;
   a third switch connected between a gate and a drain of the second input transistor; and
   a fourth switch connected between the gate and a source of the second input transistor.

(19) The imaging device according to the above (14), in which
the comparison unit includes:
   a first input transistor to which the first pixel signal is input;
   a second input transistor to which the second pixel signal is input; and
   a reference transistor to which the reference signal is input, and
the switch includes:
   a first switch that connects a drain of the first input transistor to fixed potential; and
   a second switch that connects a drain of the second input transistor to the fixed potential.

(20) The imaging device according to the above (14), in which
the comparison unit includes:
   a first input transistor to which the first pixel signal is input;
   a second input transistor to which the second pixel signal is input; and
   a reference transistor to which the reference signal is input, and
the switch includes:
   a first switch that pulls down a gate of the first input transistor; and
   a second switch that pulls down a gate of the second input transistor.

### REFERENCE SIGNS LIST

100 Imaging device
101 Optical system
102 Solid-state imaging device
103 Imaging control unit
104 Image processing unit
105 Storage unit
106 Display unit
107 Operation unit
108 Bus
111 Pixel array unit
112 Vertical scanning circuit
113 Column readout circuit
114 Column signal processing unit
115 Horizontal scanning circuit
116 Control circuit
121 Photodiode
122 Transfer transistor
123 Reset transistor
124 Amplification transistor
125 Selection transistor
PIX Pixel
HSL Horizontal drive line
VSL Vertical signal line
210, 211, 212A, 212B P-channel field effect transistor
221, 222 N-channel field effect transistor
213A, 214A, 215A, 217A, 213B, 214B, 215B, 217B, 223, 224 Switch
216A, 216B Capacitor

1. A comparator comprising:
a comparison unit that switches a plurality of input transistors to which an input signal is input and compares the input signal with a reference signal; and
a switch that prevents leakage current from flowing through an input transistor deactivated on a basis of the switching of the input transistors.

2. The comparator according to claim 1, wherein
the comparison unit includes:
a first input transistor to which the input signal is input;
a second input transistor to which the input signal is input; and
a reference transistor to which the reference signal is input, and
the switch includes:
a first switch connected in parallel with the first input transistor; and
a second switch connected in parallel with the second input transistor.

3. The comparator according to claim 2, wherein
when the input signal is switched to the first input transistor, the first switch is turned off, and the second switch is turned on, and
when the input signal is switched to the second input transistor, the first switch is turned on, and the second switch is turned off.

4. The comparator according to claim 3, further comprising:
a first capacitor connected in series with a gate of the first input transistor;
a second capacitor connected in series with a gate of the second input transistor;
a first auto-zero switch connected between the gate and a drain of the first input transistor; and
a second auto-zero switch connected between the gate and a drain of the second input transistor.

5. The comparator according to claim 4, wherein
when the first auto-zero switch is turned on, the first switch is turned off, and the second switch is turned on, and
when the second auto-zero switch is turned on, the first switch is turned on, and the second switch is turned off.

6. The comparator according to claim 1, wherein
the comparison unit includes:
a first input transistor to which the input signal is input;
a second input transistor to which the input signal is input;
a first reference transistor to which the reference signal is input; and
a second reference transistor to which the reference signal is input, and
the switch includes:
a first switch connected in parallel with the first input transistor;
a second switch connected in parallel with the second input transistor;
a third switch connected in parallel with the first reference transistor; and
a fourth switch connected in parallel with the second reference transistor.

7. The comparator according to claim 6, wherein
when the input signal is switched to the first input transistor and the reference signal is switched to the first reference transistor, the first switch and the third switch are turned off, and the second switch and the fourth switch are turned on, and
when the input signal is switched to the second input transistor and the reference signal is switched to the second reference transistor, the first switch and the third switch are turned on, and the second switch and the fourth switch are turned off.

8. The comparator according to claim 1, wherein
the comparison unit includes:
a first input transistor to which the input signal is input;
a second input transistor to which the input signal is input; and
a reference transistor to which the reference signal is input, and
the switch includes:
a first switch connected in series with a drain of the first input transistor;
a second switch connected in series with a source of the first input transistor;
a third switch connected in series with a drain of the second input transistor; and
a fourth switch connected in series with a source of the second input transistor.

9. The comparator according to claim 1, wherein
the comparison unit includes:
a first input transistor to which the input signal is input;
a second input transistor to which the input signal is input; and
a reference transistor to which the reference signal is input, and
the switch includes:
a first switch connected between a gate and a drain of the first input transistor;
a second switch connected between the gate and a source of the first input transistor;
a third switch connected between a gate and a drain of the second input transistor; and
a fourth switch connected between the gate and a source of the second input transistor.

10. The comparator according to claim 1, wherein
the comparison unit includes:
a first input transistor to which the input signal is input;
a second input transistor to which the input signal is input; and
a reference transistor to which the reference signal is input, and
the switch includes:
a first switch that connects a drain of the first input transistor to fixed potential; and
a second switch that connects a drain of the second input transistor to the fixed potential.

11. The comparator according to claim 1, wherein
the comparison unit includes:
a first input transistor to which the input signal is input;
a second input transistor to which the input signal is input; and
a reference transistor to which the reference signal is input, and
the switch includes:
a first switch that pulls down a gate of the first input transistor; and
a second switch that pulls down a gate of the second input transistor.

12. A comparator comprising:
a comparison unit that compares an input signal input to an input transistor with a reference signal input to a reference transistor; and
a switch connected in parallel with the input transistor.

13. An imaging device comprising:
a pixel array unit in which pixels are arranged in a matrix in a row direction and a column direction; and
a column ADC unit that performs analog to digital (AD) conversion for each column on a basis of a comparison result between a pixel signal read out from the pixels and a reference signal, wherein
the column ADC unit includes:
a comparison unit that switches a plurality of input transistors to which the pixel signal is input and compares the pixel signal with the reference signal; and
a switch that prevents leakage current from flowing through an input transistor deactivated on a basis of the switching of the input transistors.

14. The imaging device according to claim 13, wherein
the pixel signal includes a first pixel signal and a second pixel signal read out from the pixels at different gains.

15. The imaging device according to claim 14, wherein
the comparison unit includes:
a first input transistor to which the first pixel signal is input;
a second input transistor to which the second pixel signal is input; and
a reference transistor to which the reference signal is input, and
the switch includes:
a first switch connected in parallel with the first input transistor; and
a second switch connected in parallel with the second input transistor.

16. The imaging device according to claim 14, wherein
the comparison unit includes:
a first input transistor to which the first pixel signal is input;
a second input transistor to which the second pixel signal is input;
a first reference transistor to which the reference signal is input; and
a second reference transistor to which the reference signal is input, and
the switch includes:
a first switch connected in parallel with the first input transistor;
a second switch connected in parallel with the second input transistor;
a third switch connected in parallel with the first reference transistor; and
a fourth switch connected in parallel with the second reference transistor.

17. The imaging device according to claim 14, wherein
the comparison unit includes:
a first input transistor to which the first pixel signal is input;
a second input transistor to which the second pixel signal is input; and
a reference transistor to which the reference signal is input, and
the switch includes:
a first switch connected in series with a drain of the first input transistor;
a second switch connected in series with a source of the first input transistor;
a third switch connected in series with a drain of the second input transistor; and
a fourth switch connected in series with a source of the second input transistor.

18. The imaging device according to claim 14, wherein
the comparison unit includes:
a first input transistor to which the first pixel signal is input;
a second input transistor to which the second pixel signal is input; and
a reference transistor to which the reference signal is input, and
the switch includes:
a first switch connected between a gate and a drain of the first input transistor;
a second switch connected between the gate and a source of the first input transistor;
a third switch connected between a gate and a drain of the second input transistor; and
a fourth switch connected between the gate and a source of the second input transistor.

19. The imaging device according to claim 14, wherein
the comparison unit includes:
a first input transistor to which the first pixel signal is input;
a second input transistor to which the second pixel signal is input; and
a reference transistor to which the reference signal is input, and
the switch includes:
a first switch that connects a drain of the first input transistor to fixed potential; and
a second switch that connects a drain of the second input transistor to the fixed potential.

20. The imaging device according to claim 14, wherein
the comparison unit includes:
a first input transistor to which the first pixel signal is input;
a second input transistor to which the second pixel signal is input; and
a reference transistor to which the reference signal is input, and
the switch includes:
a first switch that pulls down a gate of the first input transistor; and
a second switch that pulls down a gate of the second input transistor.
